(19) United States
(12) Patent Application Publication
(10) Pub. No.: US 2025/0217664 A1
(43) Pub. Date: Jul. 3, 2025

(54) METHODS AND APPARATUSES FOR LEARNING AN ARTIFICIAL INTELLIGENCE OR MACHINE LEARNING MODEL

(71) Applicant: Huawei Technologies Co., Ltd., Shenzhen (CN)

(72) Inventors: Wen Tong, Ottawa (CA); Hao Tang, Ottawa (CA); Jianglei Ma, Ottawa (CA)

(21) Appl. No.: 19/055,294

(22) Filed: Feb. 17, 2025

Related U.S. Application Data
(63) Continuation of application No. PCT/CN2022/113361, filed on Aug. 18, 2022.

(51) Int. Cl. G06N 3/096; G06N 3/045; H04W 24/10

(52) U.S. Cl. CPC G06N 3/096; G06N 3/045; H04W 24/10

(57) ABSTRACT

Aspects of the present disclosure provide methods and apparatuses for learning an artificial intelligence or machine learning (AI/ML) model over a self-organized topology to enable heterogeneous neural network structures in distributed AI/ML training processes. The method comprises: a first node receives a first AI/ML model from a second node and transmits the first AI/ML mode and a model collection indicator to one or more nodes associated with the first node. The first node receives reports related to respective associated AI/ML models of its associated node(s) and generates, based on the reports, a second AI/ML model having a neural network (NN) structure equivalent to that of the first AI/ML model. However, the AI/ML models of the first node's associated node(s) may have NN structures that differ from the NN structure of the first and second AI/ML models.

### CROSS-REFERENCE TO RELATED APPLICATION

This application is a continuation of International Application No. PCT/CN2022/113361, entitled “METHODS AND APPARATUSES FOR LEARNING AN ARTIFICIAL INTELLIGENCE OR MACHINE LEARNING MODEL,” filed on Aug. 18, 2022, which is hereby incorporated by reference in its entirety.

### TECHNICAL FIELD

The present disclosure relates to wireless communication generally, and, in particular embodiments, to methods and apparatuses for learning an artificial intelligence or machine learning (AI/ML) model.

### BACKGROUND

Artificial Intelligence technologies may be applied in communication, including AI-based communication in the physical layer and/or AI-based communication in the medium access control (MAC) layer. For example, in the physical layer, the AI-based communication may aim to optimize component design and/or improve the algorithm performance. For the MAC layer, the AI-based communication may aim to utilize the AI capability for learning, prediction, and/or making a decision to solve a complicated optimization problem with possible better strategy and/or optimal solution, e.g. to optimize the functionality in the MAC layer.

In some implementations, an AI architecture in a wireless communication network may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning.

However, communications in wireless communications systems, including communications associated with AI training at multiple nodes, typically occur over non-ideal channels. For example, non-ideal conditions such as electromagnetic interference, signal degradation, phase delays, fading, and other non-idealities may attenuate and/or distort a communication signal or may otherwise interfere with or degrade the communications capabilities of the system.

Conventional AI training processes generally rely on hybrid automatic repeat request (HARQ) feedback and retransmission processes to try to ensure that data communicated between devices involved in AI training is successfully received. However, the communication overhead and delay associated with such retransmissions can be problematic.

In addition, the processing capabilities and/or availability of training data for AI training processes may vary significantly between different nodes/devices, which means that the capacity of different nodes to productively participate in an AI training process can vary significantly. In practice, such disparities often mean that training delays for AI training processes involving multiple nodes/devices, such as distributed learning or federated learning-based AI training processes, are dominated by the node/device having the largest delay due to communication delays and/or computation delays.

Federated learning, which is also known as collaborative learning, is a machine learning technique that trains an algorithm across multiple decentralized edge devices or servers. Each decentralized edge device or server holds local data samples but may not exchange with other devices or servers. The federated learning technique is opposite to traditional centralized machine learning techniques in that local data samples are not shared in the federated learning technique whereas all local datasets are uploaded to one server in traditional centralized machine learning techniques.

In wireless federated learning-based (FL-based) AI training processes, a network node/device/node initializes a global AI model, samples a group of user devices, and broadcasts the global AI model parameters to the user devices. Each user device then initializes its local AI model using the global AI model parameters, and updates (trains) its local AI model using its own data. Each user device may then report its updated local AI model's parameters to the network device, which then aggregates the updated parameters reported by the user devices and updates the global AI model. The aforementioned procedure is one iteration of a conventional FL-based AI model training procedure. The network device and the participating user devices typically perform multiple iterations until the AI model has converged sufficiently to satisfy one or more training goals/criteria and the AI model is finalized.

However, different user devices participating in an FL-based AI training process may observe different training datasets that may not be representative of the distribution of all of the training data observed by other user devices participating in the FL-based AI training process, i.e., training data may not be independently and identically distributed (non-i.i.d) at devices participating in conventional FL-based AI training processes. Non-i.i.d training data among devices has been shown to reduce the convergence speed and model accuracy in conventional FL-based AI training processes. Therefore, data heterogeneity is a typical problem in conventional FL-based AI training processes.

For these and other reasons, new protocols and signaling mechanisms are desired so that new AI-enabled applications and processes can be implemented while minimizing signaling and communication overhead and delays associated with existing AI training procedures.

### SUMMARY

There are restrictions in conventional federated learning-based (FL-based) AI training processes. For example, as stated above, data heterogeneity is a typical problem in conventional FL-based AI training processes. Also, a server node needs to collect massive amount of training data set (e.g. gradients of client node update) from multiple associated client nodes. Further, the conventional FL-based AI training processes requires server node and associated client nodes to have the same AI/ML model structure. However, since different local nodes may support different AI/ML model structures, data heterogeneity may be a problem in conventional FL-based AI training processes.

Aspects of the present disclosure provide solutions to overcome the aforementioned restrictions, for example specific methods and apparatuses for learning an artificial intelligence or machine learning (AI/ML) model over a self-organized topology.

According to a first broad aspect of the present disclosure, there is provided herein a method for learning an artificial intelligence or machine learning (AI/ML) model over a topology in a wireless communication network. The method according to the first broad aspect of the present disclosure may include receiving, by a first node from a second node, a first AI/ML model. After receiving the first AI/ML model, the first node may transmit, to one or more nodes associated with the first node, the first AI/ML model and a model collection indicator to collect AI/ML models from the one or more associated nodes. The method according to the first broad aspect of the present disclosure may further include receiving, by the first node from the one or more associated nodes, reports related to respective associated AI/ML models of the one or more associated nodes. After receiving such reports, the first node may obtain a second AI/ML model based on the reports related to the respective associated AI/ML models. The second AI/ML model may have a neural network (NN) structure equivalent to a NN structure of the first AI/ML model. The first node may also transmit the second AI/ML model to a third node.

Optionally, the respective associated AI/ML models of the one or more associated nodes may have NN structures that differ from that of the first and second AI/ML models. In other words, the respective associated AI/ML models of the one or more associated nodes are unrestricted to have NN structures equivalent to the NN structure of the first and second AI/ML models.

In some embodiments of the method according to the first broad aspect of the present disclosure, the second AI/ML model is generated using an aggregation algorithm.

In some embodiments of the method according to the first broad aspect of the present disclosure, the reports related to the respective associated AI/ML models include at least one of: acknowledgement indicators for transmissions of the respective associated AI/ML models, information related to the respective associated AI/ML models, information related to training data for the respective associated AI/ML models, or information related to performance of the respective associated AI/ML models.

In some embodiments of the method according to the first broad aspect of the present disclosure, the report related to the respective associated AI/ML models are generated by the one or more associated nodes based on the model collection indicator.

In some embodiments of the method according to the first broad aspect of the present disclosure, the model collection indicator is a dynamic indicator or an event-triggered indicator.

In some embodiments of the method according to the first broad aspect of the present disclosure, the model collection indicator is the event-triggered indicator, and the event is triggered when trainings of the respective associated AI/ML models are completed or performances of the respective associated AI/ML models exceed a performance measure predetermined based on at least one of accuracy or precision.

In some embodiments of the method according to the first broad aspect of the present disclosure, the model collection indicator includes one of: a distillation indicator; a dilation indicator; or a distillation and dilation indicator.

In some embodiments, the method according to the first broad aspect of the present disclosure further includes transmitting, by the first node to the one or more associated nodes, information regarding a reference AI/ML model.

In some embodiments of the method according to the first broad aspect of the present disclosure, the information regarding the reference AI/ML model includes information indicative of a NN structure of the reference AI/ML model including at least one of: a NN algorithm, width, depth, complexity, floating-point operations, total parameters, trainable parameters, or required buffer size.

In some embodiments of the method according to the first broad aspect of the present disclosure, obtaining the second AI/ML model includes at least one of: distilling respective associated AL/ML models into one or more distilled AI/ML models based on the model collection indicator; or dilating respective associated AL/ML models to one or more dilated AI/ML models based on the model collection indicator.

In some embodiments of the method according to the first broad aspect of the present disclosure, obtaining the second AI/ML model further includes at least one of: obtaining an average of the one or more distilled AI/ML models, or obtaining an average of the one or more dilated AI/ML models.

In some embodiments of the method according to the first broad aspect of the present disclosure, obtaining the second AI/ML model further includes obtaining an AI/ML model of the first node, and at least one of: obtaining an average of the AI/ML model of the first node and the one or more distilled AI/ML models, or obtaining an average of the AI/ML model of the first node and the one or more dilated AI/ML models.

In some embodiments of the method according to the first broad aspect of the present disclosure, obtaining the AI/ML model of the first node includes: obtaining a preliminary AI/ML model of the first node; and distilling or dilating the preliminary AI/ML model to the AI/ML model of the first node.

In some embodiments of the method according to the first broad aspect of the present disclosure, the aggregation algorithm includes at least one of model distillation or model dilation based on the model collection indicator.

In some embodiments of the method according to the first broad aspect of the present disclosure, the second AI/ML model includes one or more AI/ML model parameters excluding information related to the NN structure of the second AI/ML model.

In some embodiments of the method according to the first broad aspect of the present disclosure, the NN structure of the second AI/ML model is pre-configured.

In some embodiments, the method according to the first broad aspect of the present disclosure further includes transmitting, by the first node to one or more nodes associated with the third node, the second AI/ML model.

In some embodiments of the method according to the first broad aspect of the present disclosure, the first node performs said method iteratively.

In some embodiments of the method according to the first broad aspect of the present disclosure, at least one of the first node, the second node, the third node, or the one or more associated nodes is a base station, a user equipment (UE), a relay, a transmission and reception point (TRP), an edge device, a network device, or a network system.

According to a second broad aspect of the present disclosure, there is provided herein a method for learning an artificial intelligence or machine learning (AI/ML) model over a topology in a wireless communication network. The method according to the second broad aspect of the present disclosure may include receiving, by a first node, a first AI/ML model and a model collection indicator. After receiving the first AI/ML model and the model collection indicator, the first node may obtain a second AI/ML model. The method according to the second broad aspect of the present disclosure may further include obtaining, by the first node, a report related to the second AI/ML model. The first node may transmit, to a second node, the report related to the second AI/ML model based on the model collection indicator.

Optionally, the second AI/ML model may have a neural network (NN) structure that differs from that of the first AI/ML models. In other words, the second AI/ML model is unrestricted to have a NN structure equivalent to a NN structure of the first AI/ML model.

In some embodiments of the method according to the second broad aspect of the present disclosure, the second AI/ML model is generated based on at least one of the first AI/ML model, a local training dataset, or a local AI/ML algorithm.

In some embodiments of the method according to the second broad aspect of the present disclosure, the report related to the second AI/ML model includes at least one of: an acknowledgement indicator for transmission of the second AI/ML model, information related to the second AI/ML model, information related to training data for the second AI/ML model, or information related to performance of the second AI/ML model.

In some embodiments of the method according to the second broad aspect of the present disclosure, the first node generates the report related to the second AI/ML model based further on the model collection indicator.

In some embodiments of the method according to the second broad aspect of the present disclosure, the model collection indicator is a dynamic indicator or an event-triggered indicator.

In some embodiments of the method according to the second broad aspect of the present disclosure, the model collection indicator is the event-triggered indicator, and the event is triggered when training of the second AI/ML model is completed or performance of the second AI/ML model exceeds a performance measure predetermined based on at least one of accuracy or precision.

In some embodiments of the method according to the second broad aspect of the present disclosure, the model collection indicator includes one of: a distillation indicator; a dilation indicator; or a distillation and dilation indicator.

In some embodiments, the method according to the second broad aspect of the present disclosure further includes receiving, by the first node from the second node, information regarding a reference AI/ML model.

In some embodiments of the method according to the second broad aspect of the present disclosure, the information regarding the reference AI/ML model includes information indicative of a NN structure of the reference AI/ML model including at least one of: a NN algorithm, width, depth, complexity, floating-point operations, total parameters, trainable parameters, or required buffer size.

In some embodiments of the method according to the second broad aspect of the present disclosure, the model collection indicator is the distillation indicator, and the generated second AI/ML model is bigger than the reference AI/ML model.

In some embodiments of the method according to the second broad aspect of the present disclosure, the generated second AI/ML model has: a greater number of floating-point operations than the reference model; a greater number of total parameters than the reference model; a greater number of trainable parameters than the reference model; larger required buffer size than the reference model; width greater than the reference model; depth greater than the reference model; or any combination thereof.

In some embodiments of the method according to the second broad aspect of the present disclosure, the model collection indicator is the dilation indicator, and the generated second AI/ML model is smaller than the reference AI/ML model.

In some embodiments of the method according to the second broad aspect of the present disclosure, the generated second AI/ML model has: a fewer number of floating-point operations than the reference model; a fewer number of total parameters than the reference model; a fewer number of trainable parameters than the reference model; smaller required buffer size than the reference model; width less than the reference model; depth less than the reference model; or any combination thereof.

In some embodiments of the method according to the second broad aspect of the present disclosure, the model collection indicator is the distillation and dilation indicator, and the first node generates the second AI/ML model without restriction associated with the reference AI/ML model.

In some embodiments of the method according to the second broad aspect of the present disclosure, the first node receives the first AI/ML model and the model collection indicator from the second node.

In some embodiments of the method according to the second broad aspect of the present disclosure, the first node receives the model collection indicator from the second node and receives the first AI/ML model from a third node.

In some embodiments of the method according to the second broad aspect of the present disclosure, the first node performs said method iteratively.

In some embodiments of the method according to the second broad aspect of the present disclosure, at least one of the first node or the second node is a base station, a user equipment (UE), a relay, a transmission and reception point (TRP), an edge device, a network device, a network system.

Corresponding apparatuses and devices are disclosed for performing the methods.

For example, according to another aspect of the disclosure, a device is provided that includes a processor and a memory storing processor-executable instructions that, when executed, cause the processor to carry out a method according to the first broad aspect or the second broad aspect of the present disclosure described above.

According to other aspects of the disclosure, an apparatus including one or more units for implementing any of the method aspects as disclosed in this disclosure is provided. The term “units” is used in a broad sense and may be referred to by any of various names, including for example, modules, components, elements, means, etc. The units can be implemented using hardware, software, firmware or any combination thereof.

By virtue of some aspects of the present disclosure, AI/ML models may be routed around the wireless network. In this way, there is no need for transmitting massive amount of data (e.g. training data) among various network devices (network nodes, nodes, base stations, TRPs, etc.) and user devices (e.g. UEs). Also, heterogeneous AI/ML capability may be enabled in various network devices and user devices. Any of various network devices and user devices may be operated as aggregation node.

By virtue of some aspects of the present disclosure, AI/ML model distillation and/or dilation operations may be performed at aggregation nodes. Also, heterogeneous AI/ML model aggregation over the self-organized topology may be enabled at various network devices (network nodes, nodes, base stations, TRPs, etc.) and user devices (e.g. UEs).

By virtue of some aspects of the present disclosure, AI/ML model training may be performed dynamically. The AI/ML model training may be performed iteratively. The iteration of the AI/ML model training may be finished at desired time.

### BRIEF DESCRIPTION OF THE DRAWINGS

Reference will now be made, by way of example only, to the accompanying drawings which show example embodiments of the present application, and in which:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates illustrates four EDs communicating with a network device in a communication system, according to embodiments of the present disclosure;

FIG. 6A illustrates and example of a neural network with multiple layers of neurons, according to embodiments of the present disclosure;

FIG. 6B illustrates an example of a neuron that may be used as a building block for a neural network, according to embodiments of the present disclosure;

FIG. 7 illustrates a star topology used in a conventional federated learning (FL) procedure;

FIG. 8 illustrates difference between the conventional FL-based AI/ML model training procedure and the AI/ML model learning scheme of the present disclosure;

FIG. 9 illustrates an example self-organized topology used for an AI/ML model training, in accordance with embodiments of the present disclosure;

FIGS. 10A and 10B illustrate two different types of nodes used for learning AI/ML models, in accordance with embodiments of the present disclosure;

FIGS. 11A and 11B illustrate example self-organized topologies, in accordance with embodiments of the present disclosure;

FIG. 12 illustrates an example procedure of AI/ML model aggregation over the self-organized topology, in accordance with embodiments of the present disclosure;

FIG. 13 illustrates an example of heterogeneous AI/ML model aggregation, in accordance with embodiments of the present disclosure;

FIG. 14 illustrates an example AI/ML model distillation process in the AI/ML model aggregation over the self-organized topology, in accordance with embodiments of the present disclosure;

FIG. 15 illustrates an example AI/ML model dilation process in the AI/ML model aggregation over the self-organized topology, in accordance with embodiments of the present disclosure;

FIG. 16 illustrates an example AI/ML model distillation and dilation process in the AI/ML model aggregation over the self-organized topology, in accordance with embodiments of the present disclosure;

FIG. 17 illustrates another example AI/ML model distillation process in the AI/ML model aggregation over the self-organized topology, in accordance with embodiments of the present disclosure;

FIG. 18 illustrates another example AI/ML model dilation process in the AI/ML model aggregation over the self-organized topology, in accordance with embodiments of the present disclosure;

FIG. 19 illustrates another example AI/ML model distillation and dilation process in the AI/ML model aggregation over the self-organized topology, in accordance with embodiments of the present disclosure;

FIG. 20 illustrates another example procedure of AI/ML model aggregation over the self-organized topology, in accordance with embodiments of the present disclosure.

Similar reference numerals may have been used in different figures to denote similar components.

### DETAILED DESCRIPTION

In the present disclosure, “data collection” refers to a process of collecting data by the network nodes, management entity, or user equipment (UE) for the purpose of artificial intelligence (AI)/machine learning (ML) model training, data analytics and inference.

In the present disclosure, “AI/ML Model” refers to a data driven algorithm that applies AI/ML techniques to generate a set of outputs based on a set of inputs.

In the present disclosure, “AI/ML model training” refers to a process to train an AI/ML model by learning the input/output relationship in a data driven manner and obtain the trained AI/ML model for inference.

In the present disclosure, “AI/ML inference” refers to a process of using a trained AI/ML model to produce a set of outputs based on a set of inputs.

In the present disclosure, “Online training” refers to situations where the machine learning program is not operating and taking in new information in real time.

In the present disclosure, “Offline training” refers to situations where the machine learning program is working in real time on data that comes in.

In the present disclosure, “On-UE training” refers to online/offline training at the UE.

In the present disclosure, “On-network training” refers to online/offline training at the network.

In the present disclosure, “UE-side (AI/ML) model” refers to an AI/ML model whose inference is performed entirely at the UE

In the present disclosure, “Network-side (AI/ML) model” refers to an AI/ML model whose inference is performed entirely at the network.

In the present disclosure, “Model transfer” refers to delivery of an AI/ML model over the air interface, either parameters of a model structure known at the receiving end or a new model with parameters. Delivery may contain a full model or a partial model.

In the present disclosure, “Model download” refers to model transfer from the network to UE.

In the present disclosure, “Model upload” refers to model transfer from UE to the network.

In the present disclosure, “Model deployment” refers to delivery of a fully developed and tested model runtime image to a target UE/gNodeB (gNB) where inference is to be performed.

In the present disclosure, “Federated learning/federated training” refers to a machine learning technique that trains an AI/ML model across multiple decentralized edge nodes (e.g., UEs, gNBs) each performing local model training using local data samples. The technique requires multiple model exchanges, but no exchange of local data samples.

In the present disclosure, “Model monitoring” refers to a procedure that monitors the inference performance of the AI/ML model.

In the present disclosure, “Model update” refers to retraining or fine tuning of an AI/ML model, via online/offline training, to improve the model inference performance.

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

### Example Communication Systems and Devices

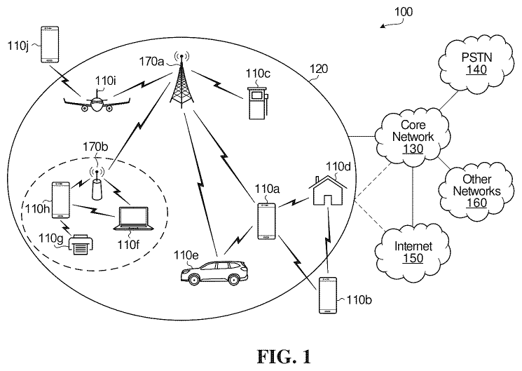

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

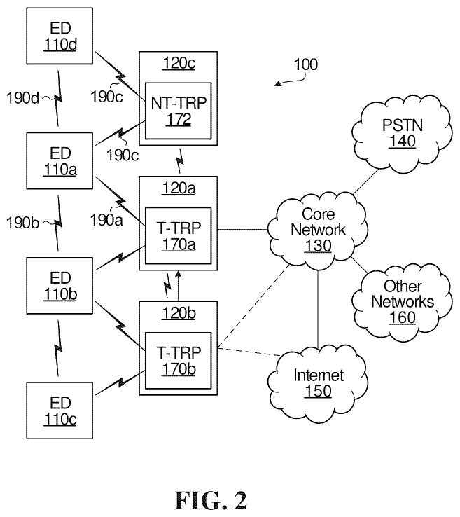

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and incorporate multiple transceivers necessary to support such.

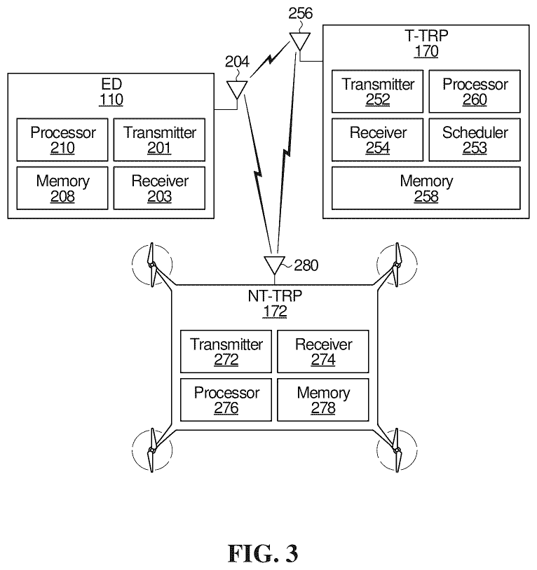

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

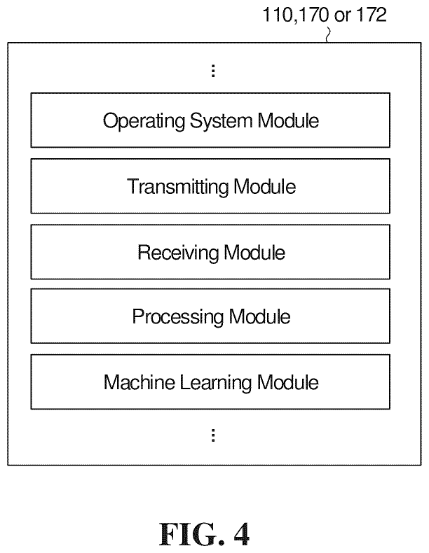

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control signaling is discussed herein in some embodiments. Control signaling may sometimes instead be referred to as signaling, or control information, or configuration information, or a configuration. In some cases, control signaling may be dynamically indicated, e.g. in the physical layer in a control channel. An example of control signaling that is dynamically indicated is information sent in physical layer control signaling, e.g. downlink control information (DCI). Control signaling may sometimes instead be semi-statically indicated, e.g. in RRC signaling or in a MAC control element (CE). A dynamic indication may be an indication in lower layer, e.g. physical layer/layer 1 signaling (e.g. in DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occur on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case, the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as Downlink Control Information (DCI), or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

### Artificial Intelligence (AI) and/or Machine Learning (ML)

The number of new devices in future wireless networks is expected to increase exponentially and the functionalities of the devices are expected to become increasingly diverse. Also, many new applications and use cases are expected to emerge with more diverse quality of service demands than those of 5G applications/use cases. These will result in new key performance indications (KPIs) for future wireless networks (for example, a 6G network) that can be extremely challenging. AI technologies, such as ML technologies (e.g., deep learning), have been introduced to telecommunication applications with the goal of improving system performance and efficiency.

In addition, advances continue to be made in antenna and bandwidth capabilities, thereby allowing for possibly more and/or better communication over a wireless link. Additionally, advances continue in the field of computer architecture and computational power, e.g. with the introduction of general-purpose graphics processing units (GP-GPUs). Future generations of communication devices may have more computational and/or communication ability than previous generations, which may allow for the adoption of AI for implementing air interface components. Future generations of networks may also have access to more accurate and/or new information (compared to previous networks) that may form the basis of inputs to AI models, e.g.: the physical speed/velocity at which a device is moving, a link budget of the device, the channel conditions of the device, one or more device capabilities and/or a service type that is to be supported, sensing information, and/or positioning information, etc. To obtain sensing information, a TRP may transmit a signal to target object (e.g. a suspected UE), and based on the reflection of the signal the TRP or another network device computes the angle (for beamforming for the device), the distance of the device from the TRP, and/or doppler shifting information. Positioning information is sometimes referred to as localization, and it may be obtained in a variety of ways, e.g. a positioning report from a UE (such as a report of the UE's GPS coordinates), use of positioning reference signals (PRS), using the sensing described above, tracking and/or predicting the position of the device, etc.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

In some embodiments, an AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

In some embodiments herein, new protocols and signaling mechanisms are provided for operating within and switching between different modes of operation for AI training, including between training and normal operation modes, and for measurement and feedback to accommodate the different possible measurements and information that may need to be fed back, depending upon the implementation.

### AI Training

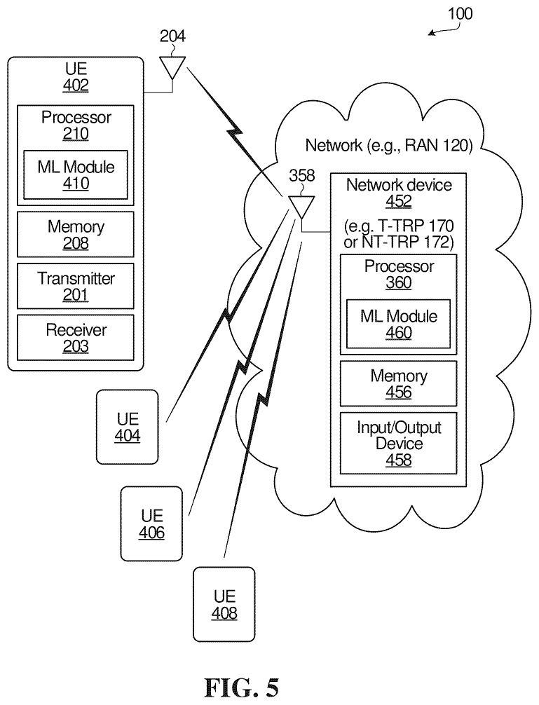

Referring again to FIGS. 1 and 2, embodiments of the present disclosure may be used to implement AI training involving two or more communicating devices in the communication system 100. For example, FIG. 5 illustrates four EDs communicating with a network device 452 in the communication system 100, according to one embodiment. The four EDs are each illustrated as a respective different UE, and will hereafter be referred to as UEs 402, 404, 406, and 408. However, the EDs do not necessarily need to be UEs.

The network device 452 is part of a network (e.g. a radio access network 120). The network device 452 may be deployed in an access network, a core network, or an edge computing system or third-party network, depending upon the implementation. The network device 452 might be (or be part of) a T-TRP or a server. In one example, the network device 452 can be (or be implemented within) T-TRP 170 or NT-TRP 172. In another example, the network device 452 can be a T-TRP controller and/or a NT-TRP controller which can manage T-TRP 170 or NT-TRP 172. In some embodiments, the components of the network device 452 might be distributed. The UEs 402, 404, 406, and 408 might directly communicate with the network device 452, e.g. if the network device 452 is part of a T-TRP serving the UEs 402, 404, 406, and 408. Alternatively, the UEs 402, 404, 406, and 408 might communicate with the network device 452 via one or more intermediary components, e.g. via a T-TRP and/or via a NT-TRP, etc. For example, the network device 452 may send and/or receive information (e.g. control signaling, data, training sequences, etc.) to/from one or more of the UEs 402, 404, 406, and 408 via a backhaul link and wireless channel interposed between the network device 452 and the UEs 402, 404, 406, and 408.

Each UE 402, 404, 406, and 408 includes a respective processor 210, memory 208, transmitter 201, receiver 203, and one or more antennas 204 (or alternatively panels), as described above. Only the processor 210, memory 208, transmitter 201, receiver 203, and antenna 204 for UE 402 are illustrated for simplicity, but the other UEs 404, 406, and 408 also include the same respective components.

For each UE 402, 404, 406, and 408, the communications link between that UE and a respective TRP in the network is an air interface. The air interface generally includes a number of components and associated parameters that collectively specify how a transmission is to be sent and/or received over the wireless medium.

The processor 210 of a UE in FIG. 5 implements one or more air interface components on the UE-side. The air interface components configure and/or implement transmission and/or reception over the air interface. Examples of air interface components are described herein. An air interface component might be in the physical layer, e.g. a channel encoder (or decoder) implementing the coding component of the air interface for the UE, and/or a modulator (or demodulator) implementing the modulation component of the air interface for the UE, and/or a waveform generator implementing the waveform component of the air interface for the UE, etc. An air interface component might be in or part of a higher layer, such as the MAC layer, e.g. a module that implements channel prediction/tracking, and/or a module that implements a retransmission protocol (e.g. that implements the HARQ protocol component of the air interface for the UE), etc. The processor 210 also directly performs (or controls the UE to perform) the UE-side operations described herein.

The network device 452 includes a processor 454, a memory 456, and an input/output device 458. The processor 454 implements or instructs other network devices (e.g. T-TRPs) to implement one or more of the air interface components on the network side. An air interface component may be implemented differently on the network-side for one UE compared to another UE. The processor 454 directly performs (or controls the network components to perform) the network-side operations described herein.

The processor 454 may be implemented by the same or different one or more processors that are configured to execute instructions stored in a memory (e.g. in memory 456). Alternatively, some or all of the processor 454 may be implemented using dedicated circuitry, such as a programmed FPGA, a GPU, or an ASIC. The memory 456 may be implemented by volatile and/or non-volatile storage. Any suitable type of memory may be used, such as RAM, ROM, hard disk, optical disc, on-processor cache, and the like.

The input/output device 458 permits interaction with other devices by receiving (inputting) and transmitting (outputting) information. In some embodiments, the input/output device 458 may be implemented by a transmitter and/or a receiver (or a transceiver), and/or one or more interfaces (such as a wired interface, e.g. to an internal network or to the internet, etc.). In some implementations, the input/output device 458 may be implemented by a network interface, which may possibly be implemented as a network interface card (NIC), and/or a computer port (e.g. a physical outlet to which a plug or cable connects), and/or a network socket, etc., depending upon the implementation.

The network device 452 and the UE 402 have the ability to implement one or more AI-enabled processes. In particular, in the embodiment in FIG. 5 the network device 452 and the UE 402 include ML modules 410 and 460, respectively. The ML module 410 is implemented by processor 210 of UE 402 and the ML module 460 is implemented by processor 454 of network device 452 and therefore the ML module 410 is shown as being within processor 210 and the ML module 460 is shown as being with processor 454 in FIG. 5. The ML modules 410 and 460 execute one or more AI/ML algorithms to perform one or more AI-enabled processes, e.g., AI-enabled link adaptation to optimize communication links between the network and the UE 402, for example.

The ML modules 410 and 460 may be implemented using an AI model. The term AI model may refer to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using various neural network architectures (e.g., autoencoders, generative adversarial networks, etc.). Various techniques may be used to train the AI model, in order to update and optimize its parameters. For example, backpropagation is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a gradient descent algorithm) to update the parameters with the goal of minimizing the loss function.

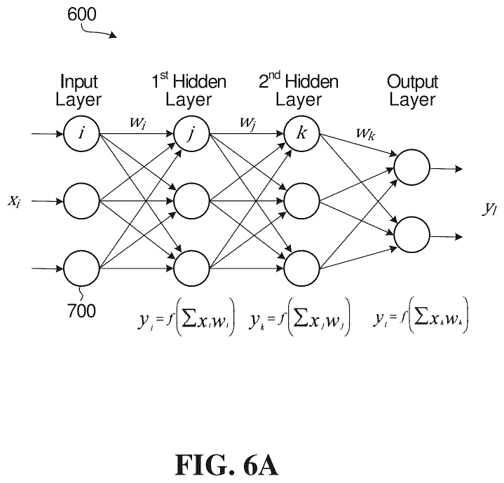

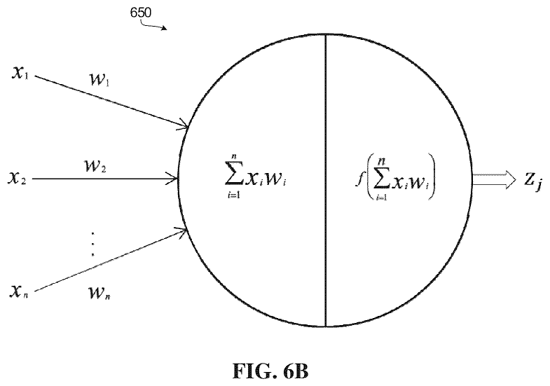

In some embodiments, an AI model encompasses neural networks, which are used in machine learning. A neural network is composed of a plurality of computational units (which may also be referred to as neurons), which are arranged in one or more layers. The process of receiving an input at an input layer and generating an output at an output layer may be referred to as forward propagation. In forward propagation, each layer receives an input (which may have any suitable data format, such as vector, matrix, or multidimensional array) and performs computations to generate an output (which may have different dimensions than the input). The computations performed by a layer typically involves applying (e.g., multiplying) the input by a set of weights (also referred to as coefficients). With the exception of the first layer of the neural network (i.e., the input layer), the input to each layer is the output of a previous layer. A neural network may include one or more layers between the first layer (i.e., input layer) and the last layer (i.e., output layer), which may be referred to as inner layers or hidden layers. For example, FIG. 6A depicts an example of a neural network 600 that includes an input layer, an output layer and two hidden layers. In this example, it can be seen that the output of each of the three neurons in the input layer of the neural network 600 is included in the input vector to each of the three neurons in the first hidden layer. Similarly, the output of each of the three neurons of the first hidden layer is included in an input vector to each of the three neurons in the second hidden layer and the output of each of the three neurons of the second hidden layer is included in an input vector to each of the two neurons in the output layer. As noted above, the fundamental computation unit in a neural network is the neuron, as shown at 650 in FIG. 6A. FIG. 6B illustrates an example of a neuron 650 that may be used as a building block for the neural network 600. As shown in FIG. 6B, in this example the neuron 650 takes a vector x as an input and performs a dot-product with an associated vector of weights w. The final output z of the neuron is the result of an activation function f( ) on the dot product. Various neural networks may be designed with various architectures (e.g., various numbers of layers, with various functions being performed by each layer).

A neural network is trained to optimize the parameters (e.g., weights) of the neural network. This optimization is performed in an automated manner and may be referred to as machine learning. Training of a neural network involves forward propagating an input data sample to generate an output value (also referred to as a predicted output value or inferred output value), and comparing the generated output value with a known or desired target value (e.g., a ground-truth value). A loss function is defined to quantitatively represent the difference between the generated output value and the target value, and the goal of training the neural network is to minimize the loss function. Backpropagation is an algorithm for training a neural network. Backpropagation is used to adjust (also referred to as update) a value of a parameter (e.g., a weight) in the neural network, so that the computed loss function becomes smaller. Backpropagation involves computing a gradient of the loss function with respect to the parameters to be optimized, and a gradient algorithm (e.g., gradient descent) is used to update the parameters to reduce the loss function. Backpropagation is performed iteratively, so that the loss function is converged or minimized over a number of iterations. After a training condition is satisfied (e.g., the loss function has converged, or a predefined number of training iterations have been performed), the neural network is considered to be trained. The trained neural network may be deployed (or executed) to generate inferred output data from input data. In some embodiments, training of a neural network may be ongoing even after a neural network has been deployed, such that the parameters of the neural network may be repeatedly updated with up-to-date training data.

Referring again to FIG. 5, in some embodiments the UE 402 and network device 452 may exchange information for the purposes of training. The information exchanged between the UE 402 and the network device 452 is implementation specific, and it might not have a meaning understandable to a human (e.g. it might be intermediary data produced during execution of a ML algorithm). It might also or instead be that the information exchanged is not predefined by a standard, e.g. bits may be exchanged, but the bits might not be associated with a predefined meaning. In some embodiments, the network device 452 may provide or indicate, to the UE 402, one or more parameters to be used in the ML module 410 implemented at the UE 402. As one example, the network device 452 may send or indicate updated neural network weights to be implemented in a neural network executed by the ML module 410 on the UE-side, in order to try to optimize one or more aspects of modulation and/or coding used for communication between the UE 402 and a T-TRP or NT-TRP.

In some embodiments, the UE 402 may implement AI itself, e.g. perform learning, whereas in other embodiments the UE 402 may not perform learning itself but may be able to operate in conjunction with an AI implementation on the network side, e.g. by receiving configurations from the network for an AI model (such as a neural network or other ML algorithm) implemented by the ML module 410, and/or by assisting other devices (such as a network device or other AI capable UE) to train an AI model (such as a neural network or other ML algorithm) by providing requested measurement results or observations. For example, in some embodiments, UE 402 itself may not implement learning or training, but the UE 402 may receive trained configuration information for an ML model determined by the network device 452 and execute the model.

Although the example in FIG. 5 assumes AI/ML capability on the network side, it might be the case that the network does not itself perform training/learning, and instead a UE may perform learning/training itself, possibly with dedicated training signals sent from the network. In other embodiments, end-to-end (E2E) learning may be implemented by the UE and the network device 452.

Using AI, e.g. by implementing an AI model as described above, various processes, such as link adaptation, may be AI-enabled. Some examples of possible AI/ML training processes and over the air information exchange procedures between devices during training phases to facilitate AI-enabled processes in accordance with embodiments of the present disclosure are described below.

Referring again to FIG. 5, for wireless federated learning (FL), the network device 452 may initialize a global AI/ML model implemented by the ML module 460, sample a group of UEs, such as the four UEs 402, 404, 406 and 408 shown in FIG. 5, and broadcast the global AI/ML model parameters to the UEs. Each of the UEs 402, 404, 406 and 408 may then initialize its local AI/ML model using the global AI/ML model parameters, and update (train) its local AI/ML model using its own data. Then each of the UEs 402, 404, 406 and 408 may report its updated local AI/ML model's parameters to the network device 452. The network device 452 may then aggregate the updated parameters reported from UEs 402, 404, 406 and 408 and update the global AI/ML model. The aforementioned procedure is one iteration of FL-based AI/ML model training procedure. The network device 452 and the UEs 402, 404, 406 and 408 perform multiple iterations until the AI/ML model has converged sufficiently to satisfy one or more training goals/criteria and the AI/ML model is finalized.

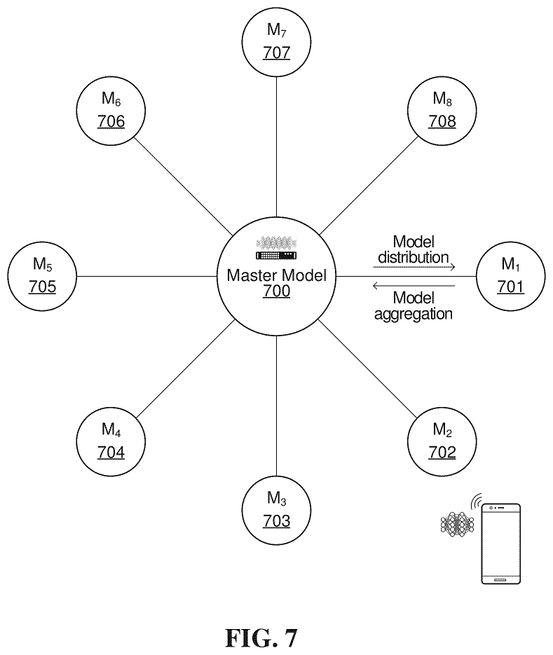

FIG. 7 illustrates an example star topology used in a conventional FL procedure. In the star topology illustrated in FIG. 7, there are a master node/device 700 (e.g. server, TRP, BS) and several client nodes/devices 701 to 708. The master node 700 initializes a master AI/ML model, samples a group of user client nodes 701 to 708, and distributes the master model (M_{M}) to the client nodes 701 to 708. The client nodes 701 to 708 then initialize their local AI/ML models M₁ to M₈ using the master AI/ML model, and update (train) their local AI/ML models M₁ to M₈ using their own data. The client nodes 701 to 708 then report their updated local AI/ML models to the master node 700. The master node 700 aggregates the updated AI/ML models M₁ to M₈, which are reported by the client nodes 701 to 708, and updates the master AI/ML model.

Such conventional FL-based AI/ML model training procedure may have some restrictions. In the star topology used in the FL-based AI/ML model training procedure, the master node 700 needs to collect massive amount of training data set (e.g. gradients of client node update) from each of the client nodes 701 to 708. In the conventional FL-based AI training procedure, the structures of the AI/ML models (e.g. master AI/ML model and local AI/ML models) need to be same. However, since different client nodes may support different AI/ML model structures, data heterogeneity may be a problem in the conventional FL-based AI training procedure.

Aspects of the present disclosure provide solutions to overcome the aforementioned restrictions, for example specific methods and apparatuses for learning an artificial intelligence or machine learning (AI/ML) model over a self-organized topology. The heterogeneous AI/ML model aggregation is supported over a self-organized topology. The methods and apparatuses illustrated in the present disclosure may be implemented and deployed in consideration of computing power of each network node and potential scale-in/scale-out for AI/ML model learning and inferencing.

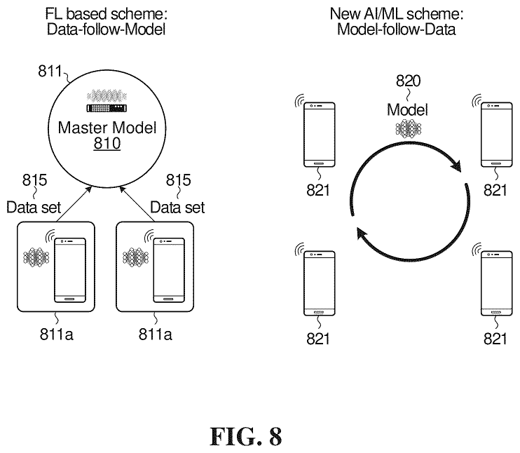

The AI/ML model learning scheme illustrated in the present disclosure is distinguished from the conventional FL-based AI/ML model training scheme. FIG. 8 illustrates difference between the conventional FL-based AI/ML model training procedure and the AI/ML model learning scheme of the present disclosure.

As illustrated in FIG. 8, the master model 810 does not move in the FL-base AI/ML model training scheme. Instead, massive amount of training data set 815 (e.g. gradients of client node update) may be transferred from client nodes 811a to a master node/device 811 which updates the master AI/ML model 810 based on the collected data. Put another way, the training data set 815 follows the AI/ML model 810 in the FL-based AI/ML model training scheme. On the contrary, in the AI/ML model learning scheme of the present disclosure, the AI/ML model 820 follows the training data set which stay at the respective network edges or nodes/devices 821. In other words, an AI/ML model 820 (e.g. a deep neural model) is routed around the network edges or nodes/devices 821 and the deep learning algorithm is executed locally at each node/device 821.

In the FL-based AI/ML model training there is only one master node/device 811 that collects AI/ML models and aggregates the collected AI/ML models. Only this master node/device 811 may be referred to as an aggregation node. On the other hand, in the AI/ML model learning scheme of the present disclosure, any node in the topology may collect AI/ML models and aggregates the collected AI/ML models, and therefore there may be several aggregation nodes (e.g. nodes 821). In effect, unlike the FL-based AI/ML model training where nodes 811 and 811a are arranged to the star-topology, a plurality of nodes/devices 821 are arranged to the self-organized topology as illustrated in FIG. 8.

Further difference between the FL-based AI/ML model training and the AI/ML model learning scheme of the present disclosure pertains to the type of data/information exchanged between the nodes. In the FL-based AI/ML model training, massive amount of training data set 815 (e.g. gradients of client node update) may be exchanged between client nodes 811a and a master node/device 811. In the AI/ML model learning scheme of the present disclosure, an AI/ML model 820 is exchanged between nodes 821.

In some embodiments, any node in the network can be a node (e.g. nodes 821 in FIG. 8) that collects one or more AI/ML models and aggregates the collected AI/ML models to generate a new or updated AI/ML model. Such node may be a Type 1 node. A Type 1 node is a node configured to collect a plurality of AI/ML models and aggregate the collected AI/ML models for generating a new or updated AI/ML model (e.g. first type AI/ML model). Such node may be also referred to as an aggregation AI/ML node or aggregation node hereinafter or elsewhere in the present disclosure. Each aggregation node (or Type 1 node) may be communicatively and/or operatively connected to or associated with another aggregation node (or Type 1 node). Each aggregation node (or Type 1 node) may be communicatively and/or operatively connected to or associated with one or more other nodes. The one or more other nodes may be Type 2 nodes. A Type 2 node is a node configured to train an AI/ML model (e.g. a second type AI/ML model, which may be also referred to as a local AI/ML model) with a set of training data (e.g. local data) without an aggregation operation. A Type 2 node may be referred to as a basic AI/ML node or basic node hereinafter or elsewhere in the present disclosure. In some embodiments, some aggregation nodes (or Type 1 nodes) may be associated with no basic node (or Type 2 node) (i.e. only associated with other aggregation nodes (or Type 1 nodes)).

In some embodiments, an AI/ML model may be transferred between nodes (e.g. BS, TRP, UE) according to the self-organized topology. In this respect, training gradient is not transmitted or shared between nodes (e.g. aggregation nodes and basic nodes) at the network level. This is because the training gradient is massive in quantity and difficult to control precisions in computing process.

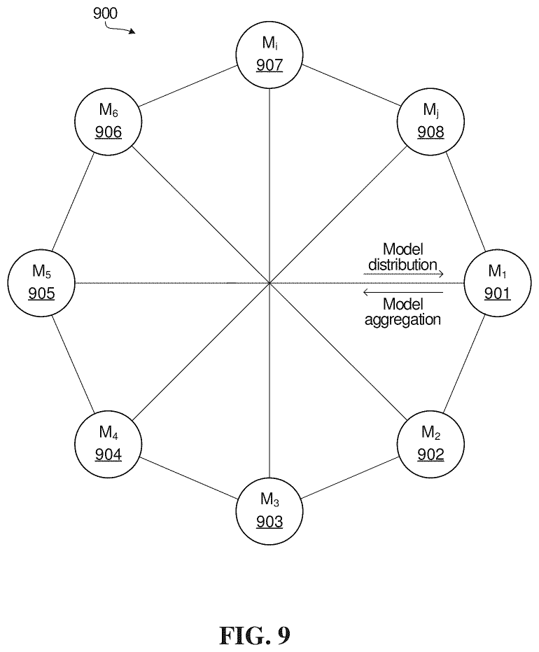

FIG. 9 illustrates an example self-organized topology 900 used for an AI/ML model training, in accordance with embodiments of the present disclosure. In the self-organized topology 900, there are a plurality of nodes 901 to 908 communicatively and operatively associated with each other. Each node holds an AI/ML model M₁ to M₈, respectively. Any node in the topology 900 can be an aggregation node.

Aggregation nodes in the topology 900 may perform one or several operations.

An aggregation node may receive an AI/ML model from another node, and send the AI/ML model without performing aggregation operation. For example, the aggregation node 901 may receive an AI/ML model from the aggregation node 902 and merely pass the AI/ML model to the node 903. The AI/ML model passed to the node 903 has not been an aggregation operation at the node 901.

An aggregation node may receive one or more AI/ML models from one or more other nodes, and send an AI/ML model with or without aggregation operation. For example, the aggregation node 901 may receive AI/ML models from the nodes 902 and 903, and aggregates the received AI/ML models M₂ and M₃. Then, the aggregation node 901 sends the aggregated AI/ML model to another node 904.

An aggregation node may generate a new or updated AI/ML model and pass the new AI/ML model to another node. For example, the aggregation node 901 generates an updated AI/ML model M₁, and passes the updated AI/ML model M₁ to the aggregation node 905.

An aggregation node may aggregate an AI/ML model that the aggregation node generates and another AI/ML model that the aggregation node receives from another node. For example, the aggregation node 901 generates its own AI/ML model M₁, and also receives an AI/ML model M₂ from the node 902. Then, the aggregation node 901 aggregates the AI/ML model M₁ and the AI/ML model M₂, and send the aggregated AI/ML model to the node 906.

In the self-organized topology, there are a plurality of nodes performing communications and computing functions. These nodes may receive at least one computing model (AI/ML model) and transmit at least one computing model (AI/ML model). While the received model and the transmitted model are not identical entity, they may have same or different data, information and/or neural network structure. The received and transmitted AI/ML models may comprise a plurality of parameters, for example one or more parameters related to a graph model, a parameters model, a model table, a model algorithm, a database.

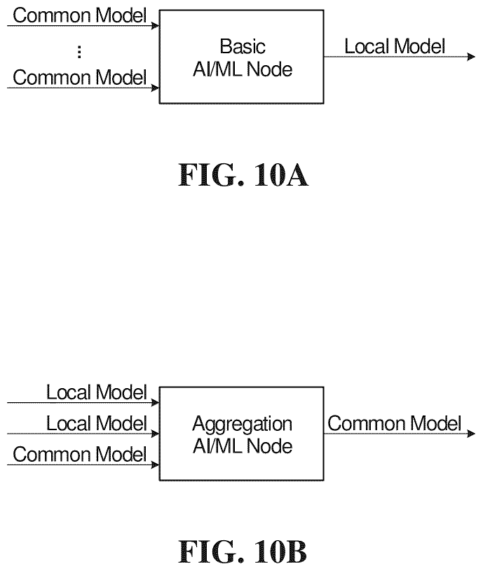

The nodes in a network may be categorized in two node types in relation to learning AI/ML models. FIGS. 10A and 10B illustrate two different types of nodes used for learning AI/ML models, in accordance with embodiments of the present disclosure. FIG. 10A illustrates one type of node that is a Type 2 node or basic AI/ML node or basic node, and FIG. 10B illustrates another type of node that is a Type 2 node or aggregation AI/ML node or aggregation node. A basic node may be also referred to as a local AI/ML node or local node.

A basic AI/ML node may receive one or more common AI/ML models from other nodes (e.g. aggregation nodes) and train its own (customized) AI/ML model. The customized AI/ML model may be referred to as local AI/ML model. The basic node trains its own local AI/ML model using its own AI/ML model training algorithm with assistance of the (current) common AI/ML models (e.g. information related to distillation and/or dilation) received from one or more aggregation nodes. In some embodiments, the neural network (NN) structure of the local AI/ML model may be same as the NN structure of at least some of the received common AI/ML models. In some embodiments, the NN structure of the local AI/ML model may be different from the NN structures of all of the received common AI/ML models. When the training of the local AI/ML model is complete, the basic node transmits the local AI/ML model to one or more other nodes (e.g. aggregation nodes).

An aggregation node may receive one or more AI/ML models from other nodes in the network. The received AI/ML models include one or more local AI/ML models from associated basic nodes and/or one or more common AI/ML models from other aggregation node(s). While the aggregation AI/ML node illustrated in FIG. 10B receives local AI/ML models, in some embodiments, the aggregation node may not receive any local AI/ML model from basic nodes (i.e. receives only common AI/ML model from other aggregation node(s)). In some embodiments, some or all of the received AI/ML models have the same NN structure. In some embodiments, all of the received AI/ML models have different NN structures. After collecting AI/ML models from other nodes, the aggregation node aggregates the collected AI/ML models (common AI/ML models, local AI/ML models) to generate a new or updated common AI/ML model. Then, the aggregation node transmits the new/updated AI/ML model to one or more other nodes.

In some embodiments, the common AI/ML model is a predefined or preconfigured AI/ML model.

As stated above, the common AI/ML models and local AI/ML models involved in AI/ML model learning process have different NN structure. For example, when an aggregation node receives one common AI/ML model and three local AI/ML models, the received AL/ML models may have all different NN structure. The common AI/ML model may be a deep neural network (DNN) model with 6 layers, a first local AI/ML model may be a DNN model with 4 layers, a second local AI/ML model may be a DNN model with 8 layers, and a third local AI/ML model may be a convolutional neural network (CNN). The NN structure may be regarded as model structure of AI/ML models.

The self-organized topology of the present disclosure includes connections between an aggregation node and one or more basic nodes and/or connections between multiple aggregation nodes.

Any network apparatus/device may be able to operate as an aggregation node in the network. An aggregation node may be communicatively and/or operatively connected to one or more basic nodes. Such connections may indicate that the aggregation node collects local AI/ML models from the associated basic nodes. However, it should be noted that in some embodiments, some aggregation node(s) may not be communicatively and/or operatively connected to any basic nodes. Such aggregation nodes may not collect local AI/ML models but only receive common AI/ML model(s) from other aggregation node(s).

It should be noted that any aggregation node and/or any basic node may be for example a UE, relay, base station (BS), transmission and reception point (TRP), edge device, edge computing system, or network system.

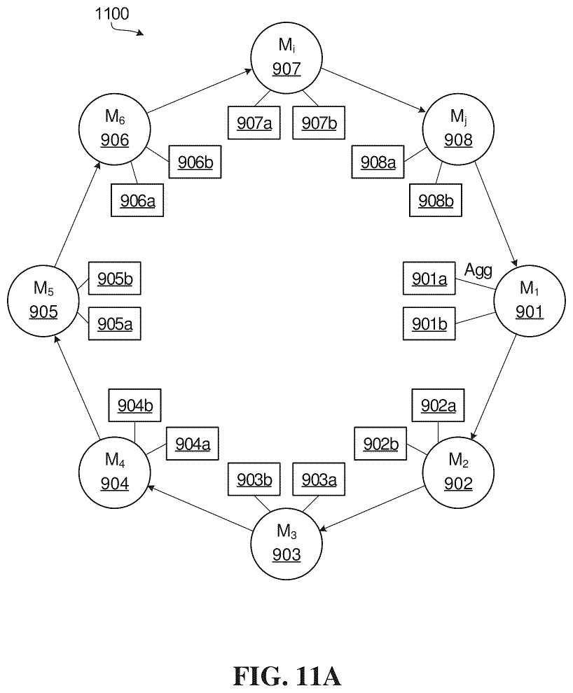

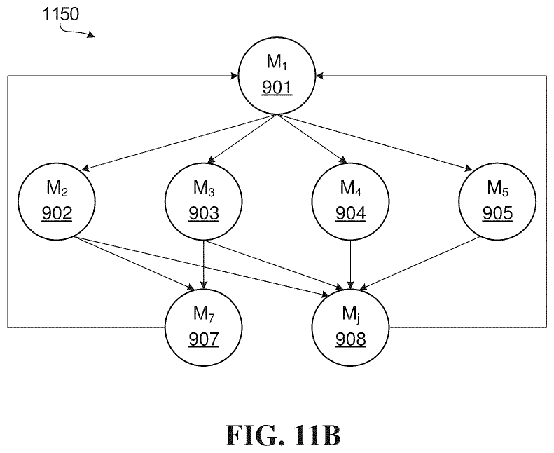

FIG. 11A illustrates an example self-organized topology 1100 in accordance with embodiments of the present disclosure. The topology 1100 includes connections between aggregation nodes and connections between aggregation nodes and basic nodes. Regarding connections between aggregation nodes, each of the aggregation nodes 901 to 908 is communicatively and operatively connected to their adjacent aggregation nodes. For example, the aggregation node 901 is communicatively and operatively connected to the aggregation nodes 902 and 908, as illustrated in FIG. 11A. In this example, this connection indicates that the aggregation node 901 may receive common AI/ML model Mⱼ from the aggregation node 908 and send its common AI/ML model M₁ to the aggregation node 902.

Regarding connections between aggregation nodes and basic nodes, each of the aggregation nodes 901 to 908 is communicatively and operatively connected to basic nodes in this example. Specifically, the aggregation node 901 is communicatively and operatively connected to basic nodes 901a and 901b. These connections indicate that the aggregation node 901 may send the common AI/ML model Mⱼ received from node 908 to the basic nodes 901a and 901b and collect local AI/ML models from the basic nodes 901a and/or 901b. Similarly, the aggregation node 902 is communicatively and operatively connected to basic nodes 902a and 902b. These connections indicate that the aggregation node 902 may send the common AI/ML model M₁ received from node 901 to the basic nodes 902a and 902b and collect local AI/ML models from the basic nodes 902a and/or 902b. Further, the aggregation node 903 is communicatively and operatively connected to basic nodes 903a and 903b. These connections indicate that the aggregation node 903 may send the common AI/ML model M₂ received from node 902 to the basic nodes 903a and 903b and collect local AI/ML models from the basic nodes 903a and/or 903b. Further, the aggregation node 904 is communicatively and operatively connected to basic nodes 904a and 904b. These connections indicate that the aggregation node 904 may send the common AI/ML model M₃ received from node 903 to the basic nodes 904a and 904b and collect local AI/ML models from the basic nodes 904a and/or 904b. Further, the aggregation node 905 is communicatively and operatively connected to basic nodes 905a and 905b. These connections indicate that the aggregation node 905 may send the common AI/ML model M₄ received from node 904 to the basic nodes 905a and 905b and collect local AI/ML models from the basic nodes 905a and/or 905b. Further, the aggregation node 906 is communicatively and operatively connected to basic nodes 906a and 906b. These connections indicate that the aggregation node 906 may send the common AI/ML model M₅ received from node 905 to the basic nodes 906a and 906b and collect local AI/ML models from the basic nodes 906a and/or 906b. Further, the aggregation node 907 is communicatively and operatively connected to basic nodes 907a and 907b. These connections indicate that the aggregation node 907 may send the common AI/ML model M₆ received from node 906 to the basic nodes 907a and 907b and collect local AI/ML models from the basic nodes 907a and/or 907b. Further, the aggregation node 908 is communicatively and operatively connected to basic nodes 908a and 908b. These connections indicate that the aggregation node 908 may send the common AI/ML model Mᵢ received from node 907 to the basic nodes 908a and 908b and collect local AI/ML models from the basic nodes 908a and/or 908b.

While each basic node in FIG. 11A is communicatively and operatively connected to only one aggregation node, in some embodiments, basic nodes may be communicatively and operatively connected to more than one aggregation node. Further, while each aggregation node in FIG. 11A is communicatively and operatively connected to some basic nodes, in some embodiments, some aggregation node(s) may not be communicatively and/or operatively connected to any basic nodes. Such aggregation nodes may not collect local AI/ML models but only receive common AI/ML model(s) from other aggregation node(s).

Provided that there is an aggregation node i in a network, the aggregation node i may receive, from one or more aggregation nodes communicatively and operatively connected to the aggregation node i, information related to respective AI/ML models. Each aggregation node that sends information related to its AI/ML model may be referred to as previous aggregation node connected to the aggregation node i. The aggregation node i may send information related to its AI/ML model to one or more other aggregation nodes that are communicatively and operatively connected to the aggregation node i. Each aggregation node that receives information related to the AI/ML model of the aggregation node i may be referred to as next aggregation node connected to the aggregation node i. In the network illustrated in FIG. 11A, for the aggregation node 902, the previous aggregation node is the aggregation node 901 and the next aggregation node is the aggregation node 903.

While the topology 1100 in FIG. 11A shows that each aggregation node has one previous aggregation node and one next aggregation node, it should be noted that aggregation nodes may have one or multiple previous aggregation nodes and one or multiple next aggregation nodes, as illustrated in FIG. 11B. FIG. 11B is another example self-organized topology 1150 illustrating connections between aggregation nodes such that each aggregation node has one or multiple previous aggregation nodes and one or multiple next aggregation nodes.

Referring to FIG. 11B, the aggregation node 901 transmits information related to its AI/ML model M₁ to the aggregation nodes 902, 903, 904 and 905. Therefore, the aggregation nodes 902 to 905 are the next aggregation nodes of the aggregation node 901. The aggregation node 901 receives from aggregation node 907 and 908 information related to their AI/ML models Mᵢ and Mⱼ. Therefore, the aggregation nodes 907 and 908 are the previous aggregation nodes of the aggregation node 901. Similarly, the aggregation nodes 902, 903, 904 and 905 transmit information related to their AI/ML models M₂, M₃, M₄ and M₅ to the aggregation nodes 907 and 908. Therefore, the aggregation nodes 907 and 908 are the next aggregation nodes of the aggregation nodes 902, 903, 904 and 905. The aggregation nodes 902, 903, 904 and 905 receive from aggregation node 901 information related to the AI/ML model M₁. Therefore, the aggregation node 901 is the previous aggregation node of 902, 903, 904 and 905. Further, the aggregation nodes 907 and 908 transmit information related to the AI/ML models Mᵢ and Mⱼ to the aggregation node 901. Therefore, the aggregation node 901 is the next aggregation node of the aggregation nodes 907 and 908. The aggregation nodes 907 and 908 receive from the aggregation nodes 902, 903, 904 and 905 information related to their AI/ML models M₂, M₃, M₄ and M₅. Therefore, the aggregation nodes 902, 903, 904 and 905 are the previous aggregation nodes of 907 and 908.

As stated above, aspects of the present disclosure provide methods for learning an artificial intelligence or machine learning (AI/ML) model over a self-organized topology. Some methods for learning an AI/ML model over a self-organized topology are illustrated below and elsewhere in the present disclosure.

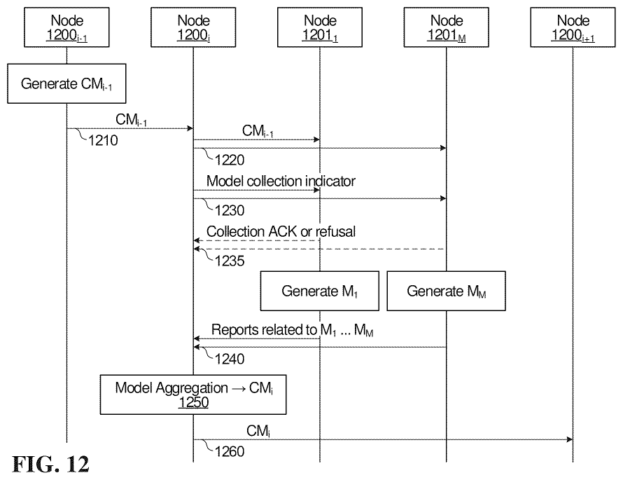

FIG. 12 illustrates an example procedure of AI/ML model aggregation over the self-organized topology, in accordance with embodiments of the present disclosure.

At step 1210, the node 1200ᵢ receives an AI/ML model CMᵢ₋₁ from the node 1200ᵢ₋₁. For example, the AI/ML model CMᵢ₋₁ may be communicated by the node 1200ᵢ₋₁ by broadcast, groupcast, or unicast signaling, e.g. by broadcast/groupcast/unicast RRC, MAC-CE or DCI, or interface between TRPs/BSs. The nodes 1200ᵢ and 1200ᵢ₋₁ may be aggregation nodes and the AI/ML model CMᵢ₋₁ may be a common AI/ML model. The node 1200ᵢ₋₁ may be a previous aggregation node of the node 1200ᵢ.

At step 1220, after receiving the AI/ML model CMᵢ₋₁, the node 1200ᵢ transmits the AI/ML model CMᵢ₋₁ to one or more of the associated nodes 1201₁ . . . 1201_{M}. For example, the AI/ML model CMᵢ₋₁ may be communicated by the node 1200ᵢ by broadcast, groupcast, or unicast signaling, e.g. by broadcast/groupcast/unicast RRC, MAC-CE or DCI, or interface between TRPs/BSs. The nodes 1201₁ . . . 1201_{M} may be basic nodes communicatively and operatively connected to the node 1200ᵢ in the self-organized topology. After receiving the AI/ML model CMᵢ₋₁ transmitted by the node 1200ᵢ. the associated nodes 1201₁ . . . 1201_{M} train their respective AI/ML models. Each of these AI/ML models may be a local AI/ML model of one of the associated nodes 1201₁ . . . 1201_{M}. Each of the associated nodes 1201₁ . . . 1201_{M} may train its (associated) AI/ML model with at least one of its own training dataset, its own AI/ML algorithm (e.g. AI/ML model training algorithm), or the AI/ML model CMᵢ₋₁ received from the node 1200ᵢ. In some embodiments, the training may be performed based on the AI/ML model CMᵢ₋₁ received from the node 1200ᵢ by transfer learning, knowledge distillation and/or knowledge dilation. The AI/ML model CMᵢ₋₁ and associated AI/ML models of the associated nodes 1201₁ . . . 1201_{M} may have the same input and/or output types. However, the AI/ML model CMᵢ₋₁ and the associated AI/ML models of the associated nodes 1201₁ . . . 1201_{M} may have different neural network (NN) structures. In other words, the associated AI/ML models of the associated nodes 1201₁ . . . 1201_{M} are not required to have NN structures equivalent to the NN structure of the AI/ML model CMᵢ₋₁.

At step 1230, the node 1200ᵢ transmits an indicator to collect AI/ML models from the associated nodes 1201₁ . . . 1201_{M}. For example, the indicator may be communicated by the node 1200ᵢ by broadcast, groupcast, or unicast signaling, e.g. by broadcast/groupcast/unicast RRC, MAC-CE or DCI, or interface between TRPs/BSs. This indicator may be referred to as model collection indicator. The node 1200ᵢ transmits the model collection indicator to the associated nodes 1201₁ . . . 1201_{M} to request reports related to respective associated AI/ML models of the associated nodes 1201₁ . . . 1201_{M}.

In some embodiments, the reports related to the associated AI/ML models of the associated nodes 1201₁ . . . 1201_{M} are generated by the associated nodes 1201₁ . . . 1201_{M} based on the model collection indicator. In such embodiments, the model collection indicator may be a dynamic indicator or an event-triggered indicator. In some embodiment where the model collection indicator is the dynamic indicator, the node 1200ᵢ receives, from the associated nodes 1201₁ . . . 1201_{M}, the reports related to the respective associated AI/ML models of the associated nodes 1201₁ . . . 1201_{M} at respective times that are preconfigured by the node 1200ᵢ. In some embodiments where the model collection indicator is the event-triggered indicator, the associated nodes 1201₁ . . . 1201_{M} transmit the reports related to the respective associated AI/ML models when a certain event is triggered. The event may be triggered when trainings of the respective associated AI/ML models of the associated nodes 1201₁ . . . 1201_{M} are completed or performances of the respective associated AI/ML models of the associated nodes 1201₁ . . . 1201_{M} exceed a certain performance measure. Said certain performance measure may be predetermined based on at least one of accuracy or precision. If performance of one of the associated AI/ML models does not exceed the predetermined performance measure (e.g. accuracy is lower than the predetermined accuracy measure), the report related to that AI/ML model may not be generated and/or transmitted to the node 1200ᵢ (e.g. no local AL/ML model report transmission).

In some embodiments, each of the associated nodes 1201₁ . . . 1201_{M}, at step 1235, optionally, sends an acknowledgement indicator for transmissions of its associated AI/ML model. For example, the acknowledgement indicator may be communicated by PUCCH or PUSCH, or sidelink channel, or an interface between TRPs/BSs. The positive acknowledgement indicator (e.g. ACK) indicates that the report related to the associated AI/ML model will be transmitted. The negative acknowledgement indicator (e.g. NACK) indicates that the report related to the associated AI/ML model will not be transmitted (e.g. no associated AI/ML model will be reported). In some embodiments, the acknowledgement indicator may be transmitted before the transmission of the report related to the associated AI/ML model. In some other embodiments, the acknowledgement indicator is included in the report related to the associated AI/ML model.

At step 1240, the associated nodes 1201₁ . . . 1201_{M} transmit, to the node 1200ᵢ, the reports related to the associated AI/ML models of the associated nodes 1201₁ . . . 1201_{M}. In some embodiments, the report related to the associated AI/ML models of the associated nodes 1201₁ . . . 1201_{M} may include at least one of information related to the respective associated AI/ML models of the associated nodes 1201₁ . . . 1201_{M}, information related to training data for the respective associated AI/ML models of the associated nodes 1201₁ . . . 1201_{M}, or information related to performance of the respective associated AI/ML models of the associated nodes 1201₁ . . . 1201_{M}. The information related to the respective associated AI/ML models may include NN structures of the associated nodes 1201₁ . . . 1201_{M} (NN algorithm, width, depth, etc.) and/or one or more AI/ML parameters (weight, bias, activation function, etc.) The information related to training data for the respective associated AI/ML models may include amount (volume) of training data and/or information related to training data distribution. The information related to performance of the respective associated AI/ML models may include accuracy, precision, recall, loss information (e.g. average cross-entropy loss), validation/test data set configured by the node 1200ᵢ (or other aggregation node or a BS). It should be noted that, in some embodiments, the information related to training data for the respective associated AI/ML models and/or the information related to performance of the respective associated AI/ML models may assist aggregation operation of aggregation nodes. For example, the training data information and/or the performance information may be used to determine AI/ML model aggregation weight.

At step 1250, after the node 1200ᵢ receives the reports related to the respective associated AI/ML models of the associated nodes 1201₁ . . . 1201_{M}, the node 1200ᵢ generates an AI/ML model CMᵢ based on the received reports. The AI/ML model CMᵢ may be an updated common AI/ML model. The AI/ML models CMᵢ₋₁ and CMᵢ may have the same NN structure. In some embodiments, the node 1200ᵢ generates the AI/ML model CMᵢ using an aggregation algorithm (e.g. model distillation, model dilation).

In some embodiments, the node 1200ᵢ may generate its own AI/ML model. This AI/ML model may be a local AI/ML model. This AI/ML model may be generated without reports related to the respective associated AI/ML models of the associated nodes 1201₁ . . . 1201_{M}.

At step 1260, the node 1200ᵢ transmits the AI/ML model CMᵢ to the node 1200ᵢ₊₁. The nodes 1200ᵢ and 1200ᵢ₊₁ may be aggregation nodes and the AI/ML model CMᵢ may be a common AI/ML model. The node 1200ᵢ₊₁ may be a next aggregation node of the node 1200ᵢ. The AI/ML model CMᵢ may include one or more AI/ML model parameters (e.g. weight, bias) but not include information related to the NN structure of the AI/ML model CMᵢ. In other words, information related to the NN structure of the AI/ML model CMᵢ may not be transmitted from the node 1200ᵢ to the node 1200ᵢ₊₁, as the NN structure of the AI/ML model CMᵢ may be pre-configured and/or the NN structure of the AI/ML model CMᵢ may be known at the node 1200ᵢ₊₁. In some embodiments, the AI/ML model CMᵢ transmitted to the node 1200ᵢ may be a full AI/ML model or a partial AI/ML model.

As stated above, the associated AI/ML models of the associated nodes 1201₁ . . . 1201_{M} are not restricted to have NN structures that are equivalent to the NN structure of the AI/ML model CMᵢ₋₁ and the AI/ML model CMᵢ. In other words, heterogeneous AI/ML model aggregation may be enabled by performing methods for learning an AI/ML model illustrated in the present disclosure.

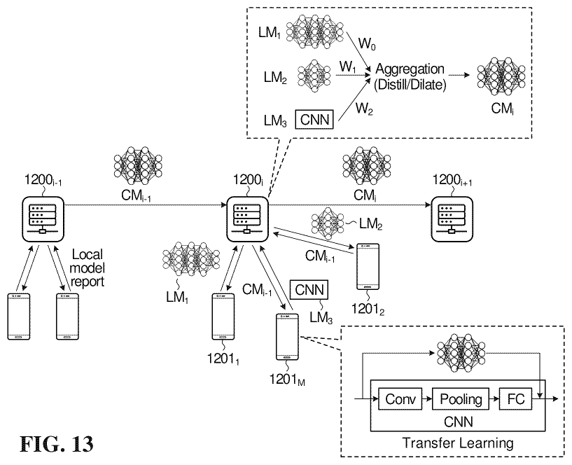

FIG. 13 illustrates an example of heterogeneous AI/ML model aggregation, in accordance with embodiments of the present disclosure. The AI/ML model aggregation procedure may be similar to the AI/ML model aggregation procedure illustrated in FIG. 12. Referring to FIG. 13, the node 1200ᵢ receives an AI/ML model CMᵢ₋₁ from the node 1200ᵢ₋₁. The AI/ML model CMᵢ₋₁ may be generated by the node 1200ᵢ₋₁ based on the local model report that the node 1200ᵢ₋₁ received. The AI/ML model CMᵢ₋₁ may include a NN with 4 layers.

The node 1200ᵢ transmits the received AI/ML model CMᵢ₋₁ to the associated nodes 1201₁, 1201₂ and 1201_{M}, respectively. The associated nodes 1201₁, 1201₂ and 1201_{M} may be basic nodes. Each of the associated nodes 1201₁, 1201₂ and 1201_{M} generates its own AI/ML model using the received AI/ML model CMᵢ₋₁. Each of the associated nodes 1201₁, 1201₂ and 1201_{M} may use its own training dataset, its own AI/ML algorithm (e.g. AI/ML model training algorithm) to generate its own local AI/ML model. The local AI/ML model LM₁ generated by the associated node 1201₁ includes a NN with 5 layers, and the local AI/ML model LM₂ generated by the associated node 1201₂ includes a NN with 3 layers. The associated node 1201_{M} may generate LM₃ that includes a convolutional neural network (CNN) by transfer learning.

After receiving reports related to local AI/ML models LM₁, LM₂ and LM₃, the node 1200ᵢ perform an aggregation operation (e.g. model distillation, model dilation) to generate an AI/ML model CMᵢ based on LM₁, LM₂ and LM₃. As each of LM₁, LM₂ and LM₃ may have different importance (significance) for generation of the AI/ML model CMᵢ, each of LM₁, LM₂ and LM₃ may be weighted with W₀, W₁ and W₂, respectively, when aggregating the local AI/ML models. W₀, W₁ and W₂ may indicate importance of LM₁, LM₂ and LM₃. The generated AI/ML model CMᵢ may be an updated common AI/ML model. The NN structure of CMᵢ may be the same as that of the AI/ML model CMᵢ₋₁. In this case, both the AI/ML model CMᵢ and AI/ML model CMᵢ₋₁ include a NN with 4 layers.

As shown above and in FIG. 13, the AI/ML model CMᵢ and the local AI/ML models LM₁, LM₂ and LM₃ may have different neural network (NN) structures. The local AI/ML models LM₁, LM₂ and LM₃ are not required to have NN structures equivalent to the NN structure of the common AI/ML models in order to generate an AI/ML models CMᵢ. In other words, heterogeneous AI/ML model aggregation over the self-organized topology is enabled.

In some embodiments, an aggregation node receives one or more heterogeneous AI/ML models from one or more associated basic nodes communicatively and operatively connected to the aggregation node. The aggregation node may distill and/or dilate the received heterogeneous AI/ML models. Then, the aggregation may aggregate the distilled and/or dilated AI/ML models to generate a new or updated common AI/ML model. In some embodiments, the aggregation node may obtain an average of the distilled AI/ML models and/or average of the dilated AI/ML models. After generating the common AI/ML model, the aggregation node may send the new/updated common AI/ML model to one or more other nodes which may be next aggregation nodes.

As stated above, an aggregation node may distill and/or dilate AI/ML models if the NN structures of the aggregation node's associated basic nodes differ from that of the aggregation node's common AI/ML model. Otherwise, if the NN structures of the aggregation node's associated basic nodes are the same as that of the aggregation node's common AI/ML model, then no distillation and/or dilation operation may be performed. The distillation and/or dilation may be part of the aggregation operation of the aggregation node. The distillation may include generating, from an AI/ML model received by the node, a smaller AI/ML model, and the dilation may include generating, from an AI/ML model received by the node, a bigger AI/ML model. Therefore, distillation of the aggregation node may include generating, by the aggregation node, a common AI/ML that is smaller than the AI/ML models received from other nodes (e.g. local AI/ML model received from associated basic nodes). Similarly, dilation of the aggregation node may include generating, by the aggregation node, a common AI/ML model that is bigger than the AI/ML models received from other nodes (e.g. local AI/ML model received from associated basic nodes).

For the purpose of illustrating distillation and/or dilation, when a first AI/ML model is bigger than a second AI/ML model, the first AI/ML model may have a greater number of floating-point operations than the second model, a greater number of total parameters than the second model, a greater number of trainable parameters than the second model, larger required buffer size than the second model, width greater than the second model, depth greater than the second model, or any combination thereof. Similarly, for the purpose of illustrating distillation and/or dilation, when a first AI/ML model is smaller than a second AI/ML model, the first AI/ML model may have a fewer number of floating-point operations than the second model, a fewer number of total parameters than the second model, a fewer number of trainable parameters than the second model, smaller required buffer size than the second model, width less than the second model, depth less than the second model, or any combination thereof.

In some embodiments, the model collection indicator transmitted by an aggregation node (e.g. model collection indicator transmitted by the node 1200ᵢ) may be a distillation indicator, a dilation indicator, or a distillation and dilation indicator. By virtue of these indicators, the aggregation node may perform operations (e.g. aggregation operation) based on its computing power.

When the aggregation node transmits a distillation indicator to one or more associated basic nodes, each associated basic node may transmit an acknowledgement indicator to the aggregation node. If an associated basic node has a local AI/ML model that is bigger than or equal to a reference AI/ML model, the associated basic node may send a positive acknowledgement indicator (e.g. ACK) and its local AI/ML model to the aggregation node. On the other hand, if an associated basic node has a local AI/ML model that is smaller than a reference AI/ML model, the associated basic node may send a negative acknowledgement indicator (e.g. NACK) to the aggregation node, but not send its local AI/ML model. Here, the reference AI/ML model may be a common AI/ML model or an AI/ML model having a certain NN structure (width, depth). Said certain NN structure may be indicated to each associated basic node by the aggregation node or indicated by a BS or network system.

In a similar manner, when the aggregation node transmits a dilation indicator to one or more associated basic nodes, each associated basic node may transmit an acknowledgement indicator to the aggregation node. If an associated basic node has a local AI/ML model that is smaller than or equal to a reference AI/ML model, the associated basic node may send a positive acknowledgement indicator (e.g. ACK) and its local AI/ML model to the aggregation node. On the other hand, if an associated basic node has a local AI/ML model that is bigger than a reference AI/ML model, the associated basic node may send a negative acknowledgement indicator (e.g. NACK) to the aggregation node, but not send its local AI/ML model. Here, the reference AI/ML model may be a common AI/ML model or an AI/ML model having a certain NN structure (width, depth). Said certain NN structure may be indicated to each associated basic node by the aggregation node or indicated by BS or network system.

When the aggregation node transmits a distillation and dilation indicator to one or more associated basic nodes, there is no restriction imposed to the associated basic nodes in relation to transmitting their local AI/ML models. In other words, all of the associated basic nodes, when receiving the distillation and dilation indicator, may transmit their local AI/ML models. Each associated basic node may optionally send a positive acknowledgement indicator (e.g. ACK).

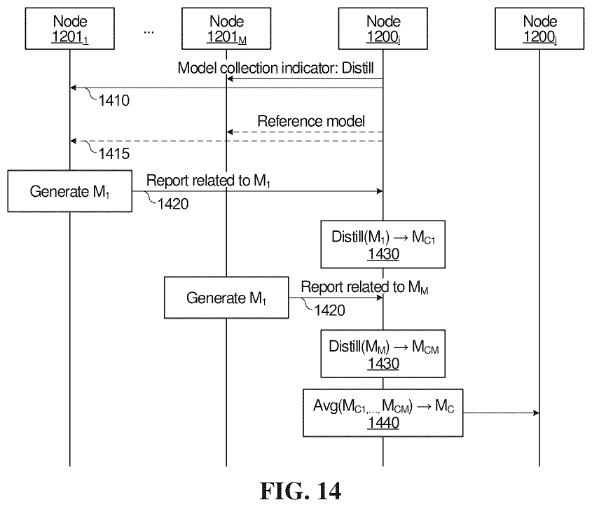

FIG. 14 illustrates an example AI/ML model distillation process in the AI/ML model aggregation over the self-organized topology, in accordance with embodiments of the present disclosure. In the AI/ML model distillation process illustrated in FIG. 14, the aggregation node may not generate its own AI/ML model (e.g. local AI/ML model of the aggregation node).

At step 1410, the node 1200ᵢ transmits a model collection indicator to each of the nodes 1201₁ . . . 1201_{M}. The model collection indicator is a distillation indicator. The node 1200ᵢ may be an aggregation node and the AI/ML model CMᵢ₋₁ may be a common AI/ML model. The nodes 1201₁ . . . 1201_{M} may be basic nodes communicatively and operatively connected to the node 1200ᵢ in the self-organized topology. In some embodiments, the node 1200ᵢ may transmit the model collection indicator to the associated nodes 1201₁ . . . 1201_{M} by broadcast, groupcast, or unicast signaling.

It should be noted that the nodes 1200ᵢ, 1200ⱼ, and 1201₁ . . . 1201_{M} may be communicatively and operatively connected in the self-organized topology over a sidelink using device-to-device (D2D) communication, through a network device (e.g. BS, TRP, etc.), or through an interface between network devices. Put another way, the nodes 1200ᵢ, 1200ⱼ, and 1201₁ . . . 1201_{M} may exchange information (e.g. model collection indicator, AI/ML model) over a sidelink using D2D communication, through a network device (e.g. BS, TRP), or through an interface between network devices. In one example where the node 1200ᵢ and the associated nodes 1201₁ . . . 1201_{M} are UEs, these nodes may exchange information (e.g. model collection indicator, AI/ML model) over a sidelink using D2D communication or through a network device (e.g. BS, TRP). The nodes may exchange information through a network device such that the aggregation node 1200ᵢ sends information to the network device (e.g. BS, TRP), and the network device sends said information to the basic nodes 1201₁ . . . 1201_{M}. In another example where the node 1200ᵢ is a BS and the associated nodes 1201₁ . . . 1201_{M} are UEs, the node 1200ᵢ and the associated nodes 1201₁ . . . 1201_{M} exchange information as uplink (UL) and/or downlink (DL) transmissions. In another example where the node 1200ᵢ and the associated nodes 1201₁ . . . 1201_{M} are BSs, these nodes may exchange information through interface(s) between the BSs. The information exchange between two aggregation nodes 1200ᵢ and 1200ⱼ may be performed, in a similar manner, over a sidelink using device-to-device (D2D) communication, through a network device (e.g. BS, TRP, etc.), or through an interface between network devices.

At step 1415, the node 1200ᵢ optionally transmits a reference AI/ML model to the associated nodes 1201₁ . . . 1201_{M}, for example by broadcast, groupcast, or unicast signaling. The reference AI/ML model may include information indicative of a NN structure of the reference AI/ML model. The information indicative of a NN structure of the reference AI/ML model may include at least one of a NN algorithm, width, depth, complexity, floating-point operations, total parameters, trainable parameters, or required buffer size. In some embodiments, the reference AI/ML model may be predefined and/or preconfigured as a common AI/ML model.

At step 1420, the associated basic nodes 1201₁ . . . 1201_{M} in the self-organized topology transmits an acknowledgement indicator and/or the report related to the associated AI/ML models of the associated nodes 1201₁ . . . 1201_{M}. For each of the associated nodes 1201₁ . . . 1201_{M}, if said associated node generates a local AI/ML model that is bigger than a reference AI/ML model, said associated node sends a positive acknowledgement indicator (e.g. ACK) and its local AI/ML model (i.e. one of AI/ML model M₁ . . . M_{M}) to the node 1200ᵢ. On the other hand, if said associated node generates a local AI/ML model that is smaller than the reference AI/ML model, said associated node sends a negative acknowledgement indicator (e.g. NACK) to the node 1200ᵢ, but does not send its local AI/ML model.

In some embodiments, the reports related to the associated AI/ML models M₁ . . . M_{M} may include at least one of information related to the respective associated AI/ML models M₁ . . . M_{M}, information related to training data for the respective associated AI/ML models M₁ . . . M_{M}, or information related to performance of the respective associated AI/ML models M₁ . . . M_{M}. The reports related to the associated AI/ML models M₁ . . . M_{M} of the associated nodes 1201₁ . . . 1201_{M} are further illustrated above or elsewhere in the present disclosure.

At step 1430, after the node 1200ᵢ receives the reports related to the respective associated AI/ML models M₁ . . . M_{M} of the associated nodes 1201₁ . . . 1201_{M}, the node 1200ᵢ distills the respective associated local AI/ML models M₁ . . . M_{M} into one or more distilled AI/ML models M_{C1} . . . M_{CM}. The node 1200ᵢ may perform distillation operation based on the model collection indicator. The one or more distilled AI/ML models M_{C1} . . . M_{CM} may be common AI/ML models with fixed size and predefined input and output parameters.

It should be noted that only local AI/ML models bigger than the reference AI/ML model may be transmitted by the associated nodes 1201₁ . . . 1201_{M} to the node 1200ᵢ. In other words, the node 1200ᵢ may distill only associated local AI/ML models that are bigger than the reference AI/ML model into distilled AI/ML models.

At step 1440, after the node 1200ᵢ obtains the distilled AI/ML models M_{C1} . . . M_{CM}, the node 1200ᵢ obtains an average of the distilled AI/ML models M_{C1} . . . M_{CM} and transmits the average AI/ML model to node 1200ⱼ. The average AI/ML model may be considered as a common AI/ML model M_{C} generated by the node 1200ᵢ. The node 1200ⱼ may be a next aggregation node of the node 1200ᵢ.

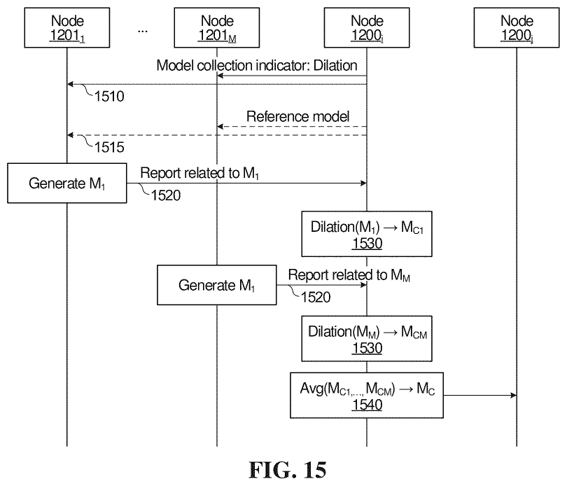

FIG. 15 illustrates an example AI/ML model dilation process in the AI/ML model aggregation over the self-organized topology, in accordance with embodiments of the present disclosure. In the AI/ML model dilation process illustrated in FIG. 15, the aggregation node may not generate its own AI/ML model (e.g. local AI/ML model of the aggregation node).

At step 1510, the node 1200ᵢ transmits a model collection indicator to each of the nodes 1201₁ . . . 1201_{M}. The model collection indicator is a dilation indicator. The node 1200ᵢ may be an aggregation node and the AI/ML model CMᵢ₋₁ may be a common AI/ML model. The nodes 1201₁ . . . 1201_{M} may be basic nodes communicatively and operatively connected to the node 1200ᵢ in the self-organized topology. In some embodiments, the node 1200ᵢ may transmit the model collection indicator to the associated nodes 1201₁ . . . 1201_{M} by broadcast, groupcast, or unicast signaling.

It should be noted that connections between the nodes 1200ᵢ, 1200ⱼ, and 1201₁ . . . 1201_{M} are illustrated above or elsewhere in the present disclosure, for example in connection to step 1410. It should be also noted that communication (e.g. information exchange) between the nodes 1200ᵢᵢ, 1200ⱼ, and 1201₁ . . . 1201_{M} may be performed in a similar manner as illustrated above or elsewhere in the present disclosure for example in connection to step 1410.

At step 1515, the node 1200ᵢ optionally transmits a reference AI/ML model to the associated nodes 1201₁ . . . 1201_{M}, for example by broadcast, groupcast, or unicast signaling. The reference AI/ML model may include information indicative of a NN structure of the reference AI/ML model. The information indicative of a NN structure of the reference AI/ML model may include at least one of a NN algorithm, width, depth, complexity, floating-point operations, total parameters, trainable parameters, or required buffer size. In some embodiments, the reference AI/ML model may be predefined and/or preconfigured as a common AI/ML model.

At step 1520, the associated basic nodes 1201₁ . . . 1201_{M} in the self-organized topology transmits an acknowledgement indicator and/or the report related to the associated AI/ML models of the associated nodes 1201₁ . . . 1201_{M}. For each of the associated nodes 1201₁ . . . 1201_{M}, if said associated node generates a local AI/ML model that is smaller than a reference AI/ML model, said associated node sends a positive acknowledgement indicator (e.g. ACK) and its local AI/ML model (i.e. one of AI/ML model M₁ . . . M_{M}) to the node 1200ᵢ. On the other hand, if said associated node generates a local AI/ML model that is bigger than the reference AI/ML model, said associated node sends a negative acknowledgement indicator (e.g. NACK) to the node 1200ᵢ, but does not send its local AI/ML model.

In some embodiments, the reports related to the associated AI/ML models M₁ . . . M_{M} may include at least one of information related to the respective associated AI/ML models M₁ . . . M_{M}, information related to training data for the respective associated AI/ML models M₁ . . . M_{M}, or information related to performance of the respective associated AI/ML models M₁ . . . M_{M}. The reports related to the associated AI/ML models M₁ . . . M_{M} of the associated nodes 1201₁ . . . 1201_{M} are further illustrated above or elsewhere in the present disclosure.

At step 1530, after the node 1200i receives the reports related to the respective associated AI/ML models M₁ . . . M_{M} of the associated nodes 1201₁ . . . 1201_{M}, the node 1200ᵢ dilates the respective associated local AI/ML models M₁ . . . M_{M} to one or more dilated AI/ML models M_{C1} . . . M_{CM}. The node 1200ᵢ may perform dilation operation based on the model collection indicator. The one or more dilated AI/ML models M_{C1} . . . M_{CM} may be common AI/ML models with fixed size and predefined input and output parameters.

It should be noted that only local AI/ML models bigger than the reference AI/ML model may be transmitted by the associated nodes 1201₁ . . . 1201_{M} to the node 1200ᵢ. In other words, the node 1200ᵢ may dilate only associated local AI/ML models that are smaller than the reference AI/ML model to dilated AI/ML models.

At step 1540, after the node 1200ᵢ obtains the dilated AI/ML models M_{C1} . . . M_{CM}, the node 1200ᵢ obtains an average of the dilated AI/ML models M_{C1} . . . M_{CM} and transmits the average AI/ML model to node 1200ⱼ. The average AI/ML model may be considered as a common AI/ML model MC generated by the node 1200ᵢ. The node 1200ⱼ may be a next aggregation node of the node 1200ᵢ.

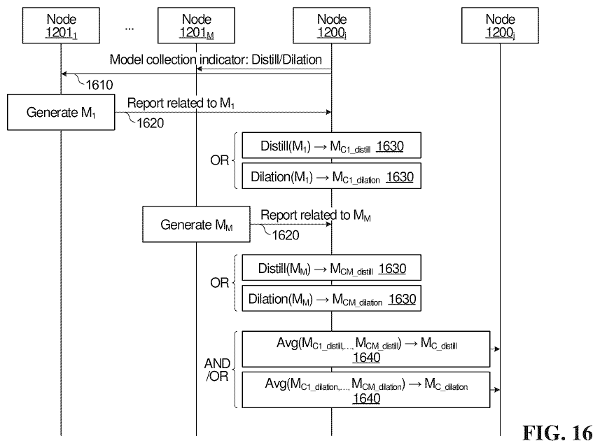

FIG. 16 illustrates an example AI/ML model distillation and dilation process in the AI/ML model aggregation over the self-organized topology, in accordance with embodiments of the present disclosure. In the AI/ML model dilation process illustrated in FIG. 16, the aggregation node may not generate its own AI/ML model (e.g. local AI/ML model of the aggregation node).

At step 1610, the node 1200ᵢ transmits a model collection indicator to each of the nodes 1201₁ . . . 1201_{M}. The model collection indicator is a distillation and dilation indicator. The node 1200ᵢ may be an aggregation node and the AI/ML model CMᵢ₋₁ may be a common AI/ML model. The nodes 1201₁ . . . 1201_{M} may be basic nodes communicatively and operatively connected to the node 1200ᵢ in the self-organized topology. In some embodiments, the node 1200ᵢ may transmit the model collection indicator to the associated nodes 1201₁ . . . 1201_{M} by broadcast, groupcast, or unicast signaling.

It should be noted that connections between the nodes 1200ᵢ, 1200ⱼ, and 1201₁ . . . 1201_{M} are illustrated above or elsewhere in the present disclosure, for example in connection to step 1410. It should be also noted that communication (e.g. information exchange) between the nodes 1200ᵢ, 1200ⱼ, and 1201₁ . . . 1201_{M} may be performed in a similar manner as illustrated above or elsewhere in the present disclosure for example in connection to step 1410.

At step 1620, the associated basic nodes 1201₁ . . . 1201_{M} in the self-organized topology transmits an acknowledgement indicator and/or the report related to the associated AI/ML models of the associated nodes 1201₁ . . . 1201_{M}. As the model collection indicator is a distillation and dilation indicator, there is no restriction with respect to transmission of the local AI/ML models M₁ . . . M_{M} of the associated basic nodes 1201₁ . . . 1201_{M}. Therefore, the associated nodes 1201₁ . . . 1201_{M} send reports related to their respective local AI/ML models M₁ . . . M_{M} to the node 1200ᵢ. Each of the associated nodes 1201₁ . . . 1201_{M} may also send a positive acknowledgement indicator (e.g. ACK) with the report.

In some embodiments, the reports related to the associated AI/ML models M₁ . . . M_{M} may include at least one of information related to the respective associated AI/ML models M₁ . . . M_{M}, information related to training data for the respective associated AI/ML models M₁ . . . M_{M}, or information related to performance of the respective associated AI/ML models M₁ . . . M_{M}. The reports related to the associated AI/ML models M₁ . . . M_{M} of the associated nodes 1201₁ . . . 1201_{M} are further illustrated above or elsewhere in the present disclosure.

At step 1630, after the node 1200ᵢ receives the reports related to the respective associated AI/ML models M₁ . . . M_{M} of the associated nodes 1201₁ . . . 1201_{M}, the node 1200ᵢ performs distill or dilation operation. For example, if a local AI/ML model of an associated basic node (i.e. one of AI/ML models M₁ . . . M_{M} of the associated nodes 1201₁ . . . 1201_{M}) is bigger than a reference AI/ML model, the node 1200ᵢ may distill said associated AL/ML model into a distilled AI/ML model (i.e. one of distilled AI/ML models M_{C1_distill} . . . M_{CM_distill}) based on the model collection indicator. On the other hand, if a local AI/ML model of an associated basic node (i.e. one of AI/ML models M₁ . . . M_{M} of the associated nodes 1201₁ . . . 1201_{M}) is smaller than a reference AI/ML model, the node 1200ᵢ may dilate said associated AL/ML model (i.e. one of AI/ML models M₁ . . . M_{M} of the associated nodes 1201₁ . . . 1201_{M}) to a dilated AI/ML model (i.e. one of dilated AI/ML models M_{C1_dilation} . . . M_{CM_dilation}) based on the model collection indicator. Each of the distilled AI/ML models M_{C1_distill} . . . M_{CM_distill} and dilated AI/ML models M_{C1_dilation} . . . M_{CM_dilation} may be a common AI/ML model with fixed size and predefined input and output parameters.

At step 1640, after the node 1200ᵢ obtains the distilled AI/ML models M_{C1_distill} . . . M_{CM_distill} and/or dilated AI/ML models M_{C1_dilation} . . . M_{CM_dilation} for all of the associated local AI/ML models, the node 1200ᵢ obtains an average of the distilled AI/ML models and an average of the dilated AI/ML models, respectively. Then, the node 1200ᵢ transmits the average distilled AI/ML model and/or the average dilated AI/ML model to node 1200ⱼ. The average distilled AI/ML model and the average dilated AI/ML model may be considered as common AI/ML model M_{C_distill} and common AI/ML model M_{C_dilation}, respectively. The node 1200ⱼ may be a next aggregation node of the node 1200ᵢ.

In some embodiments, an aggregation node may generate its own AI/ML model while still performing various operations illustrated above (e.g. receiving heterogenous AI/ML models from associated basic nodes, distilling and/or dilating multiple (local) AI/ML models to distilled and/or dilated AI/ML models, averaging the distilled and/or dilating AI/ML models to generate a new common AI/ML model, transmitting the aggregated common AI/ML model(s) to a next aggregation node). The aggregation node's own AI/ML model may be a local AI/ML model. The aggregation node's own AI/ML model may be used in the AI/ML model distillation and/or dilation processes.

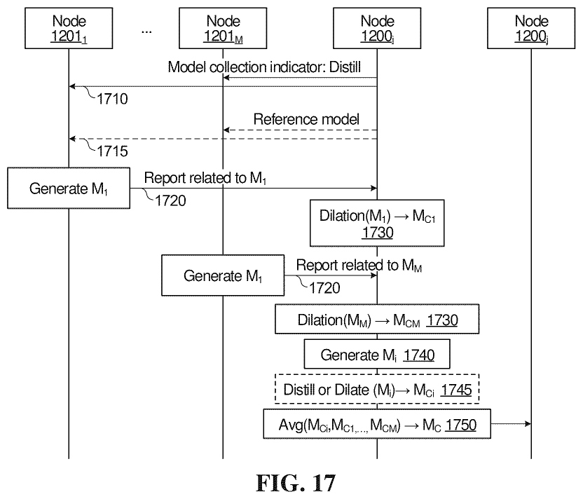

FIG. 17 illustrates another example AI/ML model distillation process in the AI/ML model aggregation over the self-organized topology, in accordance with embodiments of the present disclosure. In the AI/ML model distillation process illustrated in FIG. 17, the aggregation node generates its own AI/ML model (e.g. local AI/ML model of the aggregation node).

Steps 1710 to 1730 of the example AI/ML model distillation process illustrated in FIG. 17 are essentially similar to steps 1410 to 1430 of the example AI/ML model distillation process illustrated in FIG. 14.

At step 1740, the node 1200ᵢ generates its own AI/ML model Mᵢ. The node 1200ᵢ's own AI/ML model Mᵢ may be a local AI/ML model or a common AI/ML model. If the NN structure of the node 1200ᵢ's own AI/ML model is different from the NN structure of the common AI/ML model (e.g. common AI/ML model CMᵢ₋₁ received from a previous aggregation node 1200ᵢ₋₁ at step 1210 in FIG. 12), the node 1200ᵢ, at step 1745, performs distillation or dilation operation. For example, if the node 1200ᵢ's own AI/ML model Mᵢ is bigger than a reference AI/ML model, the node 1200ᵢ may distill the node 1200ᵢ's own AI/ML model into a distilled AI/ML model based on the model collection indicator. On the other hand, if the node 1200ᵢ's own AI/ML model is smaller than a reference AI/ML model, the node 1200ᵢ may dilate the node 1200ᵢ's own AI/ML model to a dilated AI/ML model based on the model collection indicator. The distilled or dilated AI/ML model may be a common AI/ML model M_{Ci}. However, if the NN structure of the node 1200ᵢ's own AI/ML model is same as the NN structure of the common AI/ML model (e.g. common AI/ML model CMᵢ₋₁ received from a previous aggregation node 1200ᵢ₋₁ at step 1210 in FIG. 12), then the AI/ML model Mᵢ may be considered as the AI/ML model M_{Ci}.

At step 1750, the node 1200ᵢ obtains an average of the distilled AI/ML models M_{C1} . . . M_{CM} and the (distilled or dilated) AI/ML model M_{Ci}. Then, the node 1200ᵢ transmits the average AI/ML model to node 1200ⱼ. The average AI/ML model may be considered as a common AI/ML model MC generated by the node 1200ᵢ. The node 1200ⱼ may be a next aggregation node of the node 1200ᵢ.

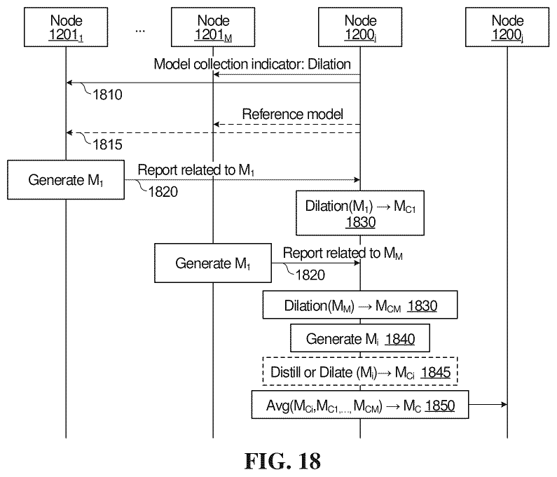

FIG. 18 illustrates another example AI/ML model dilation process in the AI/ML model aggregation over the self-organized topology, in accordance with embodiments of the present disclosure. In the AI/ML model dilation process illustrated in FIG. 18, the aggregation node may generate its own AI/ML model (e.g. local AI/ML model of the aggregation node).

Steps 1810 to 1830 of the example AI/ML model dilation process illustrated in FIG. 18 are essentially similar to steps 1510 to 1530 of the example AI/ML model dilation process illustrated in FIG. 15.

At step 1840, the node 1200ᵢ generates its own AI/ML model Mᵢ. The node 1200ᵢ's own AI/ML model Mᵢ may be a local AI/ML model or a common AI/ML model. If the NN structure of the node 1200ᵢ's own AI/ML model is different from the NN structure of the common AI/ML model (e.g. common AI/ML model CMᵢ₋₁ received from a previous aggregation node 1200ᵢ₋₁ at step 1210 in FIG. 12), the node 1200ᵢ, at step 1845, performs distillation or dilation operation. For example, if the node 1200ᵢ's own AI/ML model Mᵢ is bigger than a reference AI/ML model, the node 1200ᵢ may distill the node 1200ᵢ's own AI/ML model into a distilled AI/ML model based on the model collection indicator. On the other hand, if the node 1200ᵢ's own AI/ML model is smaller than a reference AI/ML model, the node 1200ᵢ may dilate the node 1200ᵢ's own AI/ML model to a dilated AI/ML model based on the model collection indicator. The distilled or dilated AI/ML model may be a common AI/ML model M_{Ci}. However, if the NN structure of the node 1200ᵢ's own AI/ML model is same as the NN structure of the common AI/ML model (e.g. common AI/ML model CMᵢ₋₁ received from a previous aggregation node 1200ᵢ₋₁ at step 1210 in FIG. 12), then the AI/ML model Mᵢ may be considered as the AI/ML model M_{Ci}.

At step 1850, the node 1200ᵢ obtains an average of the dilated AI/ML models M_{C1} . . . M_{CM} and the (distilled or dilated) AI/ML model M_{Ci}. Then, the node 1200ᵢ transmits the average AI/ML model to node 1200ⱼ. The average AI/ML model may be considered as a common AI/ML model MC generated by the node 1200ᵢ. The node 1200ⱼ may be a next aggregation node of the node 1200ᵢ.

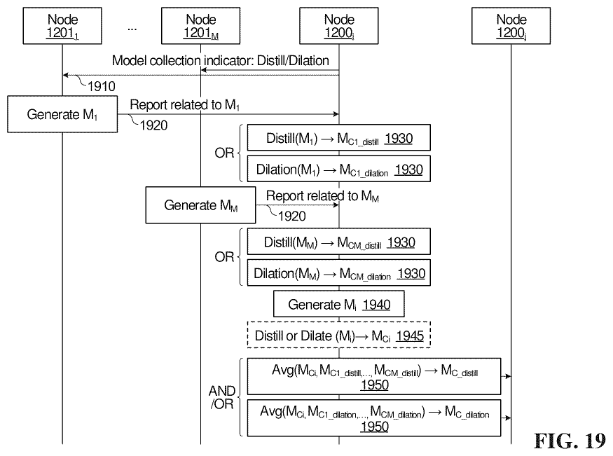

FIG. 19 illustrates an example AI/ML model distillation and dilation process in the AI/ML model aggregation over the self-organized topology, in accordance with embodiments of the present disclosure. In the AI/ML model dilation process illustrated in FIG. 19, the aggregation node may generate its own AI/ML model (e.g. local AI/ML model of the aggregation node).

Steps 1910 to 1930 of the example AI/ML model dilation process illustrated in FIG. 19 are essentially similar to steps 1610 to 1630 of the example AI/ML model distillation and dilation process illustrated in FIG. 16.

At step 1940, the node 1200ᵢ generates its own AI/ML model Mᵢ. The node 1200ᵢ's own AI/ML model Mᵢ may be a local AI/ML model or a common AI/ML model. If the NN structure of the node 1200ᵢ's own AI/ML model is different from the NN structure of the common AI/ML model (e.g. common AI/ML model CMᵢ₋₁ received from a previous aggregation node 1200ᵢ₋₁ at step 1210 in FIG. 12), the node 1200ᵢ, at step 1945, performs distillation or dilation operation. For example, if the node 1200ᵢ's own AI/ML model Mᵢ is bigger than a reference AI/ML model, the node 1200ᵢ may distill the node 1200ᵢ's own AI/ML model into a distilled AI/ML model based on the model collection indicator. On the other hand, if the node 1200ᵢ's own AI/ML model is smaller than a reference AI/ML model, the node 1200ᵢ may dilate the node 1200ᵢ's own AI/ML model to a dilated AI/ML model based on the model collection indicator. The distilled or dilated AI/ML model may be a common AI/ML model M_{Ci}. However, if the NN structure of the node 1200ᵢ's own AI/ML model is same as the NN structure of the common AI/ML model (e.g. common AI/ML model CMᵢ₋₁ received from a previous aggregation node 1200ᵢ₋₁ at step 1210 in FIG. 12), then the AI/ML model Mᵢ may be considered as the AI/ML model M_{Ci}.

At step 1950, the node 1200ᵢ obtains an average of the distilled AI/ML models M_{C1_distill} . . . M_{CM_distill} and the (distilled or dilated) AI/ML model M_{Ci}. The average of the distilled AI/ML models M_{C1_distill} . . . M_{CM_distill} and the (distilled or dilated) AI/ML model M_{Ci} may be considered as common AI/ML model M_{C_distill}. The node 1200ᵢ also obtains an average of the dilated AI/ML models M_{C1_dilation} . . . M_{CM_dilation} and the (distilled or dilated) AI/ML model M_{Ci}. The average of the dilated AI/ML models M_{C1_dilation} . . . M_{CM_dilation} and the (distilled or dilated) AI/ML model M_{Ci} may be considered as common AI/ML model M_{C_dilation}. When the node 1200ᵢ obtains the AI/ML model M_{C_distill} and/or the AI/ML model M_{C_dilation}, the node 1200ᵢ transmits the AI/ML model M_{C_distill} and/or the AI/ML model M_{C_dilation} to node 1200ⱼ. The node 1200ⱼ may be a next aggregation node of the node 1200ᵢ.

Referring to the AI/ML model aggregation processes illustrated in FIGS. 12 and 14 to 19, one or more basic nodes 1201₁ . . . 1201_{M} associated with the node 1200ᵢ receive a common AI/ML model CMᵢ₋₁ from the node 1200ᵢ. However, in some other embodiments, one or more basic nodes 1201₁ . . . 1201_{M} associated with the node 1200ᵢ may receive the common AI/ML model CMᵢ₋₁ from the previous aggregation node 1200ᵢ₋₁. In such embodiments, the one or more basic nodes 1201₁ . . . 1201_{M} may not receive the common AI/ML model CMᵢ₋₁ from the associated aggregation node 1200ᵢ or network devices (e.g. BS, TRP) or network cloud.

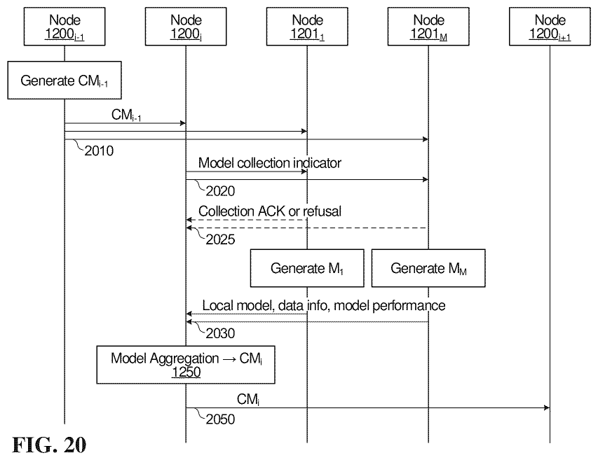

FIG. 20 illustrates another example procedure of AI/ML model aggregation over the self-organized topology, in accordance with embodiments of the present disclosure. In this procedure, the nodes 1201₁ . . . 1201_{M} may be basic nodes communicatively and operatively connected to the node 1200ᵢ in the self-organized topology, similar to the case of FIG. 12. However, the nodes 1201₁ . . . 1201_{M} may be also communicatively and operatively connected to the node 1200ᵢ₋₁. The node 1200ᵢ₋₁ may be a previous aggregation node of the aggregation node 1200ᵢ.

At step 2010, the node 1200ᵢ₋₁ transmits the AI/ML model CMᵢ₋₁ to one or more of the associated nodes 1201₁ . . . 1201_{M}. In some embodiments, the node 1200ᵢ₋₁ optionally transmits the AI/ML model CMᵢ₋₁ to the node 1200ᵢ.

The remaining operation of the step 2010 is similar to step 1220 illustrated above and FIG. 12. For example, after receiving the AI/ML model CMᵢ₋₁ from the node 1200ᵢ₋₁, each of the nodes 1201₁ . . . 1201_{M} trains its local AI/ML model based on at least one of its own training dataset, its own AI/ML algorithm (e.g. AI/ML model training algorithm), or the AI/ML model CMᵢ₋₁ received from the node 1200ᵢ₋₁. It should be noted that, similar to the process of FIG. 12, the local AI/ML models of the associated nodes 1201₁ . . . 1201_{M} are not required to have NN structures essentially similar to the NN structure of the AI/ML model CMᵢ₋₁.

Steps 2020 to 2050 of the example AI/ML model dilation process illustrated in FIG. 20 are essentially similar to steps 1230 to 1260 of the example procedure of AI/ML model aggregation process illustrated in FIG. 12. It should be noted that while the nodes 1201₁ . . . 1201_{M} receive the AI/ML model CMᵢ₋₁ from the node 1200ᵢ₋₁, the nodes 1201₁ . . . 1201_{M} receive the model collection indicator from the node 1200ᵢ and transmit their respective local AI/ML models M₁ . . . M_{M} to the node 1200ᵢ.

In some embodiments, provided that one AI/ML model training iteration comprises receiving a common AI/ML model from the previous aggregation node, receiving local AI/ML models from communicatively and operatively connected basic nodes, and transmitting a new/updated common AI/ML model to the next aggregation node, the aggregation node (e.g. nodes 901 to 908 in FIG. 11A) may join one or more AI/ML model training iterations. In other words, the aggregation node may perform methods for learning an AI/ML model (e.g. AI/ML model aggregation processes) illustrated in the present disclosure, iteratively.

For example, referring to FIG. 11A, the AI/ML model training is performed at the aggregation node 901. Then, the AI/ML model training is performed at each of other aggregation nodes 902 to 908 in a predetermined order. When the AI/ML model training is complete at the aggregation node 908, then each aggregation node in the self-organized topology 1100 has performed one AI/ML model training iteration.

In another example, still referring to FIG. 11A, the AI/ML model training is started at the aggregation node 901. Then, the AI/ML model training is performed at each of other aggregation nodes 902 to 908 in a predetermined order. When the AI/ML model training is complete at the aggregation node 908, the aggregation node 908 transmits the updated common AI/ML model to the aggregation node 901. This is one round of the AI/ML model training. The next round of the AI/ML model training is started at the aggregation node 901 in a similar manner. The AI/ML model training may be temporarily suspended or finished at any aggregation node in the self-organized topology 1100. In this way, each aggregation node may perform one or more AI/ML model training iterations.

By virtue of some aspects of the present disclosure, AI/ML models may be routed around the wireless network. In this way, there is no need for transmitting massive amount of data (e.g. training data) among various network devices (network nodes, nodes, base stations, TRPs, etc.) and user devices (e.g. UEs). Also, heterogeneous AI/ML capability may be enabled in various network devices and user devices. Any of various network devices and user devices may be operated as aggregation node.

By virtue of some aspects of the present disclosure, AI/ML model distillation and/or dilation operations may be performed at aggregation nodes. Also, heterogeneous AI/ML model aggregation over the self-organized topology may be enabled at various network devices (network nodes, nodes, base stations, TRPs, etc.) and user devices (e.g. UEs).

By virtue of some aspects of the present disclosure, AI/ML model training may be performed dynamically. The AI/ML model training may be performed iteratively. The iteration of the AI/ML model training may be finished at desired time.

Examples of devices (e.g. ED or UE and TRP or network device) to perform the various methods described herein are also disclosed.

For example, a first device may include a memory to store processor-executable instructions, and a processor to execute the processor-executable instructions. When the processor executes the processor-executable instructions, the processor may be caused to perform the method steps of one or more of the devices as described herein, e.g. in relation to FIGS. 12 and 14-20. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

### DEFINITIONS OF ACRONYMS

LTE Long Term Evolution
NR New Radio
BWP Bandwidth part
BS Base Station
CA Carrier Aggregation
CC Component Carrier
CG Cell Group
CSI Channel state information
CSI-RS Channel state information Reference Signal
DC Dual Connectivity
DCI Downlink control information
DL Downlink
DL-SCH Downlink shared channel
EN-DC E-UTRA NR dual connectivity with MCG using E-UTRA and SCG using NR
gNB Next generation (or 5G) base station
HARQ-ACK Hybrid automatic repeat request acknowledgement
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE Target UE
UCI Uplink control information
UE User Equipment
UL Uplink
UL-SCH Uplink shared channel

1. A method, the method comprising:
receiving, by a first node from a second node, a first artificial intelligence or machine learning (AI/ML) model;
transmitting, by the first node to one or more nodes associated with the first node, the first AI/ML model and a model collection indicator to collect AI/ML models from the one or more associated nodes;
receiving, by the first node from the one or more associated nodes, reports related to respective associated AI/ML models of the one or more associated nodes;
obtaining, by the first node, a second AI/ML model based on the reports related to the respective associated AI/ML models, the second AI/ML model having a neural network (NN) structure equivalent to a NN structure of the first AI/ML model; and
transmitting, by the first node to a third node, the second AI/ML model.

2. The method of claim 1, wherein the respective associated AI/ML models of the one or more associated nodes are unrestricted to have NN structures equivalent to the NN structure of the first AI/ML model and the NN structure of the second AI/ML model.

3. The method of claim 1, wherein the reports related to the respective associated AI/ML models include at least one of:
acknowledgement indicators for transmissions of the respective associated AI/ML models,
information related to the respective associated AI/ML models,
information related to training data for the respective associated AI/ML models, or
information related to performance of the respective associated AI/ML models.

4. The method of claim 1, wherein the model collection indicator includes one of:
a distillation indicator;
a dilation indicator; or
a distillation and dilation indicator.

5. The method of claim 4, further comprising:
transmitting, by the first node to the one or more associated nodes, information regarding a reference AI/ML model.

6. A method, the method comprising:
receiving, by a first node, a first artificial intelligence or machine learning (AI/ML) model and a model collection indicator;
obtaining, by the first node, a second AI/ML model;
obtaining, by the first node, a report related to the second AI/ML model; and
transmitting, by the first node to a second node, the report related to the second AI/ML model based on the model collection indicator.

7. The method of claim 6, wherein the report related to the second AI/ML model includes at least one of:
an acknowledgement indicator for transmission of the second AI/ML model,
information related to the second AI/ML model,
information related to training data for the second AI/ML model, or
information related to performance of the second AI/ML model.

8. The method of claim 6, wherein the model collection indicator includes one of:
a distillation indicator;
a dilation indicator; or
a distillation and dilation indicator.

9. The method of claim 8, further comprising:
receiving, by the first node from the second node, information regarding a reference AI/ML model.

10. The method of claim 9, wherein the information regarding the reference AI/ML model includes information indicative of a neural network (NN) structure of the reference AI/ML model including at least one of: an NN algorithm of the reference AI/ML model, a width of the reference AI/ML model, a depth of the reference AI/ML model, complexity of the reference AI/ML model, floating-point operations of the reference AI/ML model, total parameters of the reference AI/ML model, trainable parameters of the reference AI/ML model, or a required buffer size of the reference AI/ML model.

11. An apparatus for a node, the apparatus comprising:
at least one processor; and
a memory storing processor-executable instructions that, when executed, cause the apparatus to:
receive, from a second node, a first artificial intelligence or machine learning (AI/ML) model;
transmit, to one or more nodes associated with the node, the first AI/ML model and a model collection indicator to collect AI/ML models from the one or more associated nodes;
receive, from the associated node, reports related to respective associated AI/ML models of the one or more associated nodes;
obtain, a second AI/ML model based on the reports related to the respective associated AI/ML models, the second AI/ML model having a neural network (NN) structure equivalent to a NN structure of the first AI/ML model; and
transmit, to a third node, the second AI/ML model.

12. The apparatus of claim 11, wherein the respective associated AI/ML models of the one or more associated nodes are unrestricted to have NN structures equivalent to the NN structure of the first AI/ML model and the NN structure of the second AI/ML model.

13. The apparatus of claim 11, wherein the reports related to the respective associated AI/ML models include at least one of:
acknowledgement indicators for transmissions of the respective associated AI/ML models,
information related to the respective associated AI/ML models,
information related to training data for the respective associated AI/ML models, or
information related to performance of the respective associated AI/ML models.

14. The apparatus of claim 11, wherein the model collection indicator includes one of:
a distillation indicator;
a dilation indicator; or
a distillation and dilation indicator.

15. The apparatus of claim 14, wherein the processor-executable instructions further comprise processor-executable instructions that, when executed, cause the apparatus to:
transmit, by the node to the one or more associated nodes, information regarding a reference AI/ML model.

16. An apparatus for a node, the apparatus comprising:
at least one processor; and
a memory storing processor-executable instructions that, when executed, cause the apparatus to:
receive a first artificial intelligence or machine learning (AI/ML) model and a model collection indicator;
obtain a second AI/ML model;
obtain a report related to the second AI/ML model; and
transmit, to a second node associated with the node, the report related to the second AI/ML model based on the model collection indicator.

17. The apparatus of claim 16, wherein the report related to the second AI/ML model includes at least one of:
an acknowledgement indicator for transmission of the second AI/ML model,
information related to the second AI/ML model,
information related to training data for the second AI/ML model, or
information related to performance of the second AI/ML model.

18. The apparatus of claim 16, wherein the model collection indicator includes one of:
a distillation indicator;
a dilation indicator; or
a distillation and dilation indicator.

19. The apparatus of claim 18, wherein the processor-executable instructions further comprise processor-executable instructions that, when executed, cause the apparatus to:
receive, by the apparatus from the second node, information regarding a reference AI/ML model.

20. The apparatus of claim 19, wherein the information regarding the reference AI/ML model includes information indicative of a neural network (NN) structure of the reference AI/ML model including at least one of: an NN algorithm of the reference AI/ML model, a width of the reference AI/ML model, a depth of the reference AI/ML model, complexity of the reference AI/ML model, floating-point operations of the reference AI/ML model, total parameters of the reference AI/ML model, trainable parameters of the reference AI/ML model, or a required buffer size of the reference AI/ML model.
